(19) United States
(12) Patent Application Publication
(10) Pub. No.: US 2019/0278994 A1
(43) Pub. Date: Sep. 12, 2019

(54) PHOTOGRAPH DRIVEN VEHICLE IDENTIFICATION ENGINE

(71) Applicant: Capital One Services, LLC, McLean, VA (US)

(72) Inventors: Derek Bumpas, Allen, TX (US); Stewart Youngblood, Allen, TX (US); Mithra Kosur Venuraju, Frisco, TX (US); Amit Deshpande, McKinney, TX (US); Jason Hoover, Grapevine, TX (US); Daniel Martinez, Dallas, TX (US); William Hardin, Dallas, TX (US); Satish Chikkaveerappa, McKinney, TX (US); Majaliwa Bass, Carrollton, TX (US); Jacob Guiles, Wylie, TX (US); Sona Solbrook, Dallas, TX (US); Valerie Colon, Little Elm, TX (US); Khai Ha, The Colony, TX (US); Micah Price, Plano, TX (US); Qiaochu Tang, The Colony, TX (US); Stephen Wylie, Carrollton, TX (US); Geoffrey Dagley, McKinney, TX (US); Jeremy Huang, Plano, TX (US); Venkata Satya Parcha, Mckinney, TX (US)

(73) Assignee: Capital One Services, LLC, McLean, VA (US)

(21) Appl. No.: 16/151,280

(22) Filed: Oct. 3, 2018

Related U.S. Application Data
(63) Continuation-in-part of application No. 15/915,329, filed on Mar. 8, 2018, now Pat. No. 10,223,611.
(60) Provisional application No. 62/640,437, filed on Mar. 8, 2018.
(60) Provisional application No. 62/641,214, filed on Mar. 9, 2018.

(51) Int. Cl. G06K 9/00; G06N 3/08; G06F 17/30

(52) U.S. Cl. CPC G06K 9/00671; G06T 3/40; G06F 17/30247; G06N 3/08

(57) ABSTRACT

Disclosed herein are systems and methods for a photograph driven vehicle identification system. In some embodiments, a system for image-based vehicle identification includes a database, an image processor, and a vehicle search engine. The database can include vehicle information. The image processor may apply one or more machine learning models on images received by a user device. The user device can include a camera that obtains the images. The user device can provide a display having images of a vehicle and information associated with the vehicle through a user interface (UI) of the user device. The display can include a first portion at a first location of the UI, and a second portion at a second location of the UI. The first portion and the second portion may be provided at a single instance. The vehicle search engine may identify one or more vehicles in the images received.

### CROSS REFERENCE TO RELATED APPLICATIONS

The present disclosure is a continuation-in-part application of and claims the benefit of application Ser. No. 15/915,329 entitled “Object Detection Using Image Classification Models,” filed Mar. 8, 2018. The present disclosure claims the benefit under 35 U.S.C. §119(e) of U.S. Provisional Application No. 62/640,437 entitled “Photograph Driven Vehicle Identification Engine,” filed Mar. 8, 2018, and U.S. Provisional Application No. 62/641,214 entitled “Photograph Driven Vehicle Identification Engine,” filed Mar. 9, 2018 and hereby incorporated by reference.

### TECHNICAL FIELD

The present disclosure is generally directed towards a search engine that is capable of identifying vehicles based on a photograph.

### BACKGROUND

Machine learning (ML) can be applied to various computer vision applications, including object detection and image classification (or “image recognition”). General object detection can be used to locate an object (e.g., a car or a bird) within an image, whereas image classification may involve a relatively fine-grained classification of the image (e.g., a 1969 Beetle, or an American Goldfinch). Convolutional Neural Networks (CNNs) are commonly used for both image classification and object detection. A CNN is a class of deep, feed-forward artificial neural networks that has successfully been applied to analyzing visual imagery. Generalized object detection may require models that are relatively large and computationally expensive, presenting a challenge for resource-constrained devices such as some smartphones and tablet computers. In contrast, image recognition may use relatively small models and require relatively little processing.

Also, conventional search engines that identify vehicles (e.g., used car websites, car dealership websites, car financing websites, rental car services, parking services) attempt to identify vehicles based on a user input that includes the make (i.e., manufacturer) and model of the car. Often a user may not be privy to the make or model of the car they are looking for, making conventional search engines frustrating and/or impossible to use.

Conventional search engines that identify vehicles using photographs (e.g., police/federal databases, transit polls) often take an image of a license plate and apply optical character recognition to the image in order to obtain the license plate number. The systems then look up the license plate and associated vehicle identification number (VIN) using a database. These systems are limited in that they pose privacy issues, and are only able to pull an exact vehicle. Pulling an exact vehicle may not be useful when a user is trying to locate vehicles similar to the one they photograph (rather than the exact vehicle).

Conventional products that provide comparisons between vehicles may require a user to visit a variety of websites. Conventional products that provide comparisons between vehicles may also require a user to provide answers to a plurality of data fields such as mileage, pricing, customer ratings, body style, etc. before identifying cars and providing comparison information. Often a user may not be privy to the data fields for the car they are looking for, making conventional vehicle comparison products frustrating and/or impossible to use.

### SUMMARY

According to one aspect of the present disclosure, a system for image-based vehicle identification includes a database, an image processor, and a vehicle search engine. The database includes a plurality of vehicle information. The image processor may apply one or more machine learning models on one or more images received by a user device. In some configurations, the user device includes a camera that obtains one or more images. In some configurations, the user device provides a display having one or more images of a vehicle and information associated with the vehicle through a user interface of the user device. The display may include a first portion provided at a first location of the user interface, and a second portion provided at a second location different from the first location. The user interface provides each of the first portion and the second portion at a single instance (i.e. same time). The vehicle search engine may identify one or more vehicles in the images received from the user device.

In some embodiments, each of the one or more machine learning models identify a plurality of objects in the received images, at least one of the plurality of objects is a vehicle. In some embodiments, the vehicle search engine may identify a plurality of vehicle image coordinates corresponding to the one or more vehicles in the images received from the user device using a Single Shot Detector Inception machine learning model. In some embodiments, the image data processor may generate a detailed vehicle information based on the vehicle information retrieved from the database for each of the identified vehicles. For example, the detailed vehicle information may include at least one of: a mileage information, a pricing information, a vehicle stock information, a location of a vehicle dealer, a color information, one or more customer rating information, and a body style information. In some embodiments, the image data processor may generate an augmented image for each of the identified vehicles by overlaying the detailed vehicle information upon an image of at least one of the identified vehicles. In some embodiments, the user device may display the augmented image for each of the identified vehicles through the user interface of the user device. In some embodiments, the vehicle search engine may identify at least one of: a number of vehicles, a plurality of vehicle image coordinates for each vehicle, and a plurality of dimensions for each vehicle.

In some embodiments, the image data processor identifies a plurality of vehicle image co-ordinates for each identified vehicle; performs a cropping of each of the one or more received images in accordance with the identified vehicle image co-ordinates; generates one or more cropped images from the one or more received images; and stores the generated cropped images of the identified vehicle in the database. In some embodiments, the image data processor performs the cropping of each of the one or more received images based on a scaling of the identified vehicle image co-ordinates in accordance with a plurality of parameters associated with the one or more received images.

Another aspect of the present disclosure is a method for image-based vehicle identification. The method includes receiving one or more images from a user device, extracting one or more parameters corresponding to at least one of the received images, providing the determined one or more parameters as input to one or more machine learning models, obtaining, as an output from the one or more machine learning models, a prediction of one or more vehicle information, each vehicle information corresponding to a vehicle in the obtained one or more images, identifying, from the one or more predicted vehicle information obtained from the one or more machine learning models, one or more vehicles matching the vehicle in the obtained one or more images, and presenting a display with the one or more identified vehicles to the user device. In some configurations, at least one of the one or more machine learning models is a Single Shot Detector Inception machine learning model.

In some embodiments, the method includes for each of the vehicles identified from the one or more predicted vehicle information, generating a detailed vehicle information based on a vehicle information retrieved from a database. In some embodiments, the detailed vehicle information includes at least one of: a mileage information, a pricing information, a vehicle stock information, a location of a vehicle dealer, a color information, one or more customer rating information, and a body style information. In some embodiments, the method further includes, generating an augmented image for each of the identified vehicles by overlaying the detailed vehicle information upon an image of at least one of the one or more identified vehicles. In some embodiments, the method further includes, displaying the augmented image for each of the identified vehicles through an user interface of the user device. In some embodiments, the one or more predicted vehicle information includes at least one of: a number of vehicles, a plurality of vehicle image coordinates for each vehicle, and a plurality of dimensions for each vehicle.

In some embodiments, the method further includes, identifying a plurality of vehicle image co-ordinates for each identified vehicle matching the vehicle in the obtained one or more images, performing a cropping of each of the one or more received images in accordance with the identified vehicle image co-ordinates, generating one or more cropped images from the one or more received images, and storing the generated cropped images of the identified vehicle in a database. In some embodiments, performing the cropping of each of the one or more received images is based on a scaling of the identified vehicle image co-ordinates in accordance with a plurality of parameters associated with the one or more received images. In some embodiments, the Single Shot Detector Inception machine learning model is configured to identify a plurality of vehicle image co-ordinates corresponding to the one or more vehicles in the one or more images received from the user device.

Another aspect of the present disclosure is a non-transitory computer-readable storage medium including instructions executable by a processor. The instructions may comprise: receiving one or more images from a user device; extracting one or more parameters corresponding to at least one of the received images; identifying, based on inputting the extracted one or more parameters to one or more machine learning models, one or more vehicles matching a vehicle in the images received from the user device, at least one of the one or more machine learning models being a Single Shot Detector Inception machine learning model that identifies vehicle image co-ordinates corresponding to the one or more vehicles in the one or more images received from the user device; generating an augmented image for each of the identified vehicles based on overlaying a vehicle information upon an image of at least one of the one or more identified vehicles; and transmitting the augmented image to the user device for display.

### BRIEF DESCRIPTION OF THE DRAWINGS

FIG. 1 is a block diagram of a system for object detection and image classification, according to some embodiments of the present disclosure;

FIG. 2 is a diagram illustrating a convolutional neural network (CNN), according to some embodiments of the present disclosure;

FIGS. 3A, 3B, 4A, and 4B illustrate object detection techniques, according to some embodiments of the present disclosure;

FIG. 5 is a flow diagram showing processing that may occur within the system of FIG. 1, according to some embodiments of the present disclosure; and

FIG. 6 is a block diagram of a user device, according to an embodiment of the present disclosure.

FIG. 7 illustrates a system diagram for a photograph driven vehicle identification system, according to an aspect of the present disclosure.

FIG. 8 illustrates a method for a photograph driven vehicle identification system, according to an aspect of the present disclosure.

FIGS. 9-23 illustrate one or more user interfaces for a photograph driven vehicle identification system, according to an aspect of the present disclosure.

FIGS. 24A-24B illustrate a process for vehicle identification and comparison, according to an aspect of the present disclosure.

FIGS. 25A-25B illustrate a process for vehicle pricing by photo and saving vehicle pricing to a wish list to visit later, according to an aspect of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

Described herein are systems and methods for object detection using image classification models. In some embodiments, an image is processed through a single-pass convolutional neural network (CNN) trained for fine-grained image classification. Multi-channel data may be extracted from the last convolution layer of the CNN. The extracted data may be summed over all channels to produce a 2-dimensional matrix referred herein as a “general activation map.” the general activation maps may indicate all the discriminative image regions used by the CNN to identify classes. This map may be upscaled and used to see the “attention” of the model and used to perform general object detection within the image. “Attention” of the model pertains to which segments of the image the model is paying most “attention” to is based on values calculated up through the last convolutional layer that segments the image into a grid (e.g., a 7×7 matrix). The model may give more “attention” to segments of the grid that have higher values, and this corresponds to the model predicting that an object is located within those segments. In some embodiments, object detection is performed in a single-pass of the CNN, along with fine-grained image classification. In some embodiments, a mobile app may use the image classification and object detection information to provide augmented reality (AR) capability.

Some embodiments are described herein by way of example using images of specific objects, such as automobiles. The concepts and structures sought to be protected herein are not limited to any particular type of images.

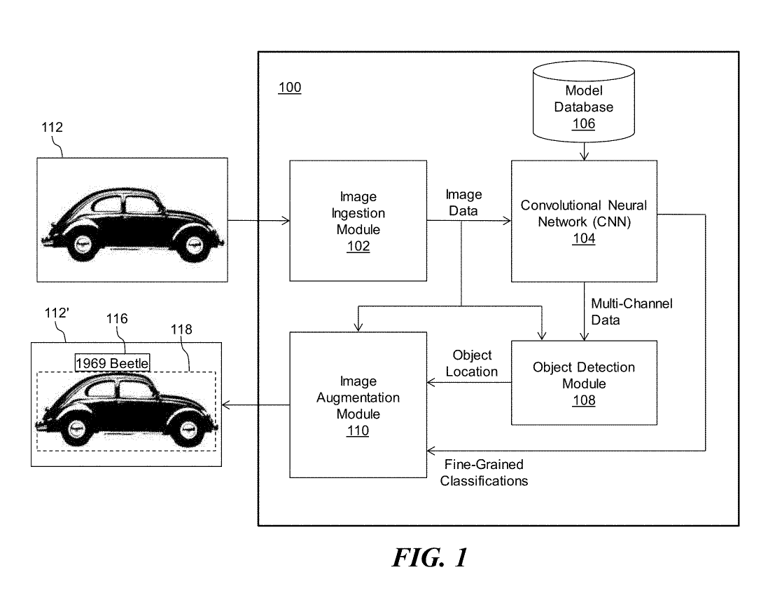

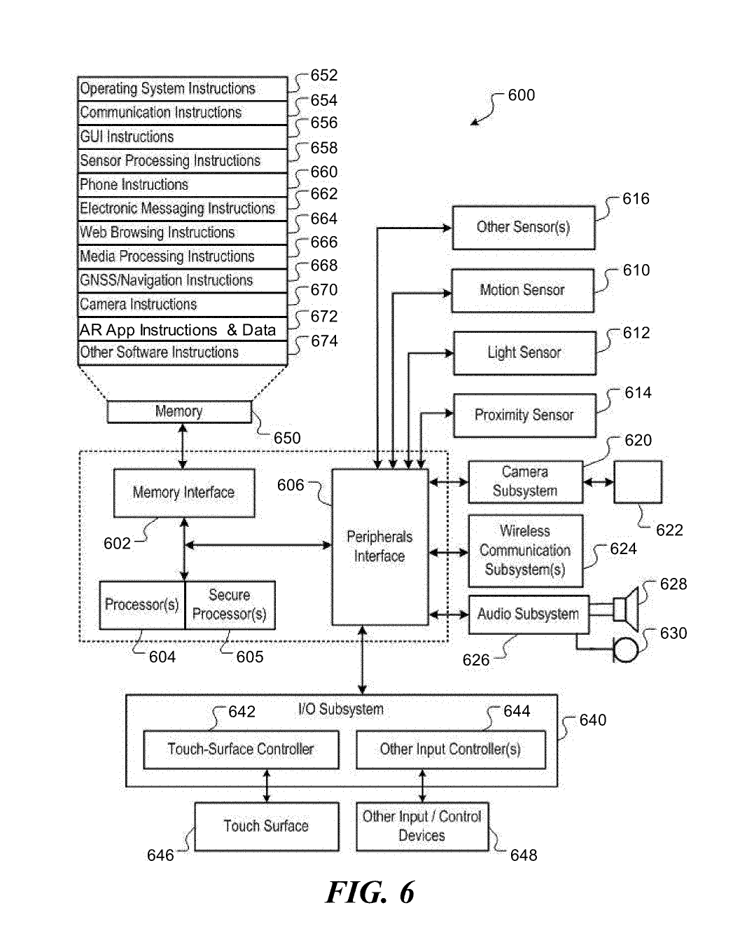

Referring to FIG. 1, a system 100 may perform object detection and image classification, according to some embodiments of the present disclosure. The illustrative system 100 includes an image ingestion module 102, a convolutional neural network (CNN) 104, a model database 106, an object detection module 108, and an image augmentation module 110. Each of the modules 102, 104, 108, 110 may include software and/or hardware configured to perform the processing described herein. In some embodiments, the system modules 102, 104, 108, 110 may be embodied as computer program code executable on one or more processors (not shown). The modules 102, 104, 108, 110 may be coupled as shown in FIG. 1 or in any suitable manner. In some embodiments, the system 100 may be implemented within a user device, such as user device 600 described below in the context of FIG. 6.

The image ingestion module 102 receives an image 112 as input. The image 112 may be provided in any suitable format, such as Joint Photographic Experts Group (JPEG), Portable Network Graphics (PNG), or Graphics Interchange Format (GIF). In some embodiments, the image ingestion module 102 includes an Application Programming Interface (API) via which users can upload images.

The image ingestion module 102 may receive images having an arbitrary width, height, and number of channels. For example, an image taken with a digital camera may have a width of 640 pixels, a height of 960 pixels, and three (3) channels (red, green, and blue) or one (1) channel (greyscale). The range of pixel values may vary depending on the image format or parameters of a specific image. For example, in some cases, each pixel may have a value between 0 to 255.

The image ingestion module 102 may convert the incoming image 112 into a normalized image data representation. In some embodiments, an image may be represented as C 2-dimensional matrices stacked over each other (one for each channel C), where each of the matrices is a WxH matrix of pixel values. The image ingestion module 102 may resize the image 112 to have dimensions WxH as needed. The values W and H may be determined by the CNN architecture. In one example, W=224 and H=224. The normalized image data may be stored in memory until it has been processed by the CNN 104.

The image data may be sent to an input layer of the CNN 104. In response, the CNN 104 generates one or more classifications for the image at an output layer. The CNN 104 may use a transfer-learned image classification model to perform “fine-grained” classifications.

For example, the CNN may be trained to recognize a particular automobile make, model, and/or year within the image. As another example, the model may be trained to recognize a particular species of bird within the image. In some embodiments, the trained parameters of the CNN 104 may be stored within a non-volatile memory, such as within model database 106. In certain embodiments, the CNN 104 uses an architecture similar to one described in A. Howard et al., “MobileNets: Efficient Convolutional Neural Networks for Mobile Vision Applications,” which is incorporated herein by reference in its entirety.

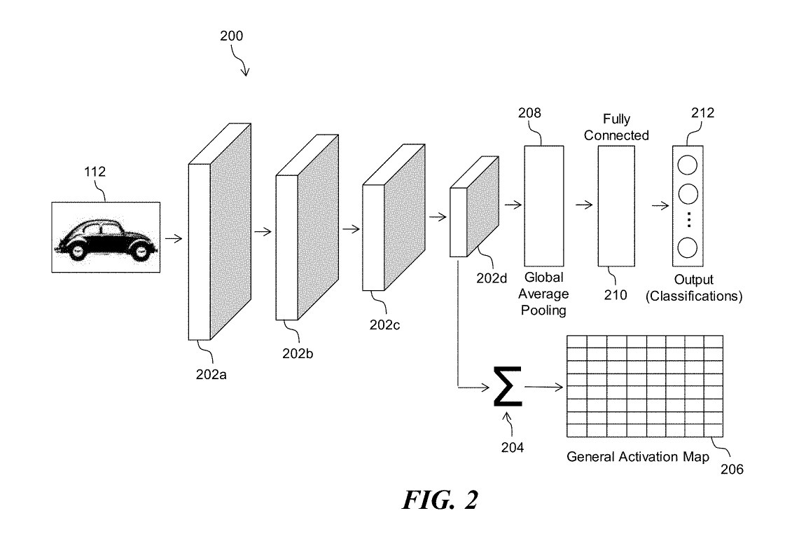

As will be discussed further below in the context of FIG. 2, the CNN 104 may include a plurality of convolutional layers arranged in series. The object detection module 108 may extract data from the last convolutional layer in this series and use this data to perform object detection within the image. In some embodiments, the object detection module 108 may extract multi-channel data from the CNN 104 and sum over the channels to generate a “general activation map.” This map may be upscaled and used to see the “attention” of the image classification model, but without regard to individual classifications or weights. For example, if the CNN 104 is trained to classify particular makes/models/years of automobiles within an image, the general activation map may approximately indicate where any automobile is located with the image.

The object detection module 108 may generate, as output, information describing the location of an object within the image 112. In some embodiments, the object detection module 108 outputs a bounding box that locates the object within the image 112.

The image augmentation module 110 may augment the original image to generate an augmented image 112′ based on information received from the CNN 104 and the objection detection module 108. In some embodiments, the augmented image 112′ includes the original image 112 overlaid with some content (“content overlay”) 116 that is based on CNN's fine-grained image classification. For example, returning to the car example, the content overlay 116 may include the text “1969 Beetle” if the CNN 104 classifies an image of a car as having model “Beetle” and year “1969.” The object location information received from the object detection module 108 may be used to position the content overlay 116 within the 112′. For example, the content overlay 116 may be positioned along a top edge of a bounding box 118 determined by the object detection module 108. The bounding box 118 is shown in FIG. 1 to aid in understanding, but could be omitted from the augmented image 112′.

In some embodiments, the system 100 may be implemented as a mobile app configured to run on a smartphone, tablet, or other mobile device such as user device 600 of FIG. 6. In some embodiments, the input image 112 be received from a mobile device camera, and the augmented output image 112′ may be displayed on a mobile device display. In some embodiments, the app may include augmented reality (AR) capabilities. For example, the app may allow a user to point their mobile device camera at an object and, in real-time or near real-time, see an augmented version of that object based on the object detection and image classification. In some embodiments, the mobile app may augment the display with information pulled from a local or external data source. For example, the mobile app may use the CNN 104 to determine a vehicle's make/model/year and then automatically retrieve and display loan rate information from a bank for that specific vehicle.

FIG. 2 shows an example of a convolutional neural network (CNN) 200, according to some embodiments of the present disclosure. The CNN 200 may include an input layer (not shown), a plurality of convolutional layers 202a-202d (202 generally), a global average pooling (GAP) layer 208, a fully connected layer 210, and an output layer 212.

The convolutional layers 202 may be arranged in series as shown, with a first convolutional layer 202a coupled to the input layer, and a last convolutional layer 202d coupled to the GAP layer 208. The layers of the CNN 200 may be implemented using any suitable hardware- or software-based data structures and coupled using any suitable hardware- or software-based signal paths. The CNN 200 may be trained for fine-grained image classification. In particular, each of the convolutional layers 202 along with the GPA 208 and fully connected layer 210 may have associated weights that are adjusted during training such that the output layer 212 accurately classifies images 112 received at the input layer.

Each convolutional layer 202 may include a fixed-size feature map that can be represented as a 3-dimensional matrix having dimensions W′×H'×D', where D′ corresponds to the number of layers (or “depth”) within that feature map. The dimensions of the convolutional layers 202 may be irrespective of the images being classified. For example, the last convolution layer 202 may have width W′=7, height H′=7, and depth D′=1024, regardless of the size of the image 112.

After putting an image 112 through a single pass of a CNN 200, multi-channel data may be extracted from the last convolutional layer 202d. A general activation map 206 may be generated by summing 204 over all the channels of the extracted multi-channel data. For example, if the last convolution layer 202d is structured as a 7×7 matrix with 1024 channels, then the extracted multi-channel data would be a 7×7×1024 matrix and the resulting general activation map 206 would be a 7×7 matrix of values, where each value corresponds to a sum over 1024 channels. In some embodiments, the general activation map 206 is normalized such that each of its values is in the range [0, 1]. The general activation map 206 can be used to determine the location of an object within the image. In some embodiments, the general activation map 206 can be used to determine a bounding box for the object within the image 112.

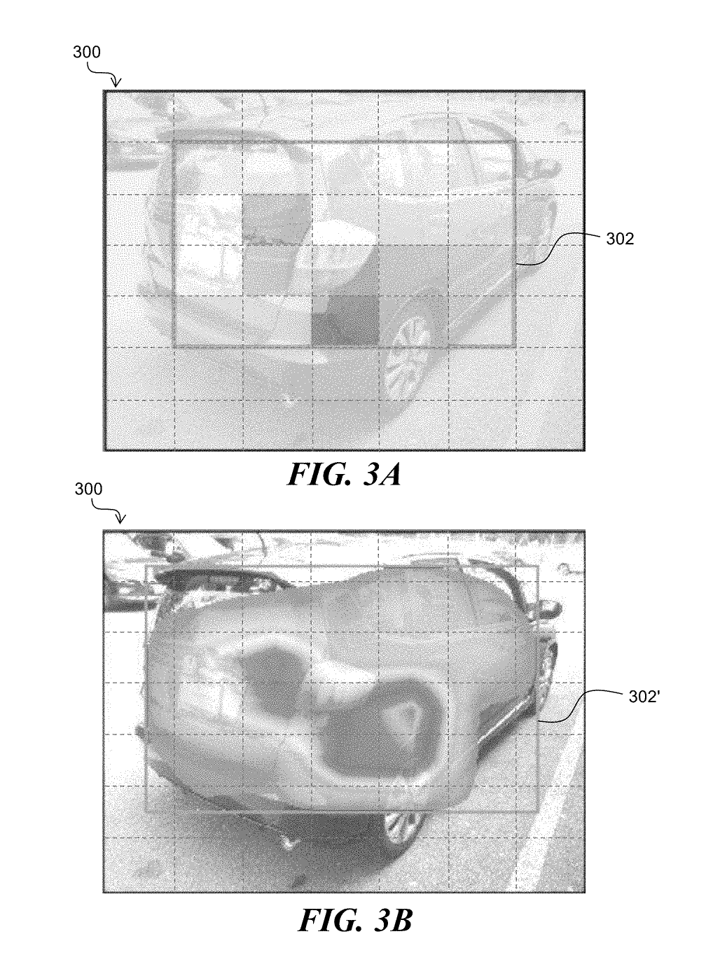

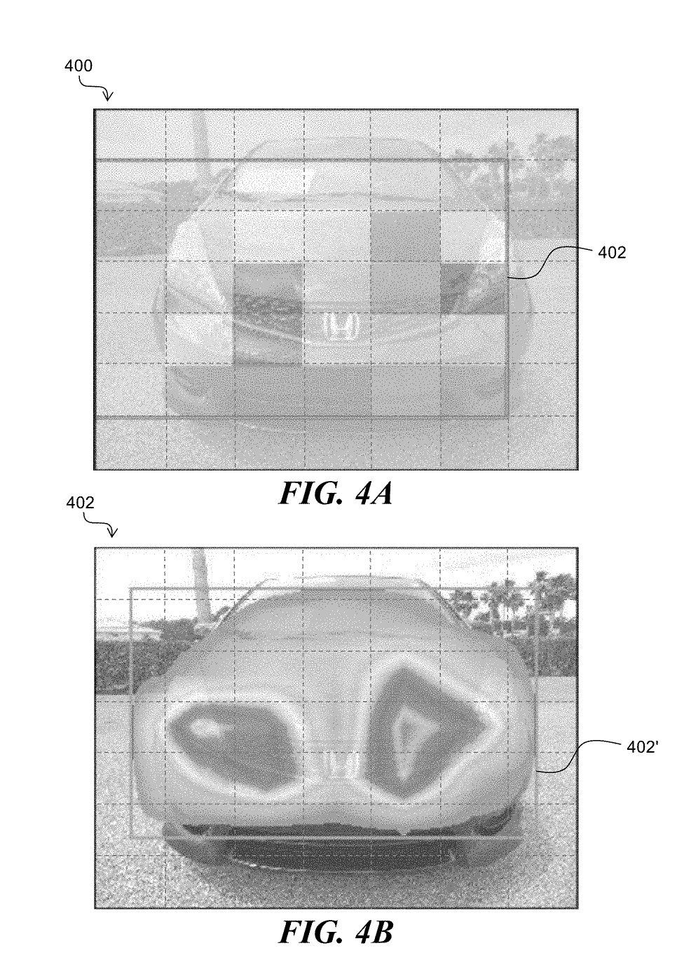

FIGS. 3A, 3B, 4A, and 4B illustrate object detection using a general activation map, such as general activation map 206 of FIG. 2. In each of these figures, a 7×7 general activation map is shown overlaid on an image and depicted using dashed lines. The overlaid map may be upscaled according to the dimensions of the image. For example, if the image has dimensions 700×490 pixels, then the 7×7 general activation map may be upscaled such that each map element corresponds to 100×70 pixel area of the image. Each element of the general activation map has a value calculated by summing multi-channel data extracted from the CNN (e.g., from convolutional layer 202d in FIG. 2). The map values are illustrated in FIGS. 3A, 3B, 4A, and 4B by variations in color (i.e., as a heat map), but which colors have been converted to greyscale for this disclosure.

Referring to FIG. 3A, an object may be detected within the image 300 using a 7×7 general activation map. In some embodiments, each value within the map is compared to a predetermined threshold value and a bounding box 302 may be drawn around the elements of the map that have values above the threshold. The bounding box 302 approximately corresponds to the location of the object within the image 300. In some embodiments, the threshold value may be a parameter that can be adjusted based on a desired granularity for the bounding box 302. For example, the threshold value may be lowered to increase the size of the bounding box 302, or raised to decrease the size of the bounding box 302.

Referring to FIG. 3B, in some embodiments, the general activation map may be interpolated to achieve a more accurate (i.e., “tighter”) bounding box 302′ for the object. Any suitable interpolation technique can be used. In some embodiments, a predetermined threshold value is provided as a parameter for the interpolation process. A bounding box 302′ can then be drawn around the interpolated data, as shown. In contrast to the bounding box 302 in FIG. 3A, the bounding box 302′ in FIG. 3B may not align with the upscaled general activation map boundaries (i.e., the dashed lines in the figures).

FIGS. 4A and 4B illustrate object detection using another image 400. In FIG. 4A, a bounding box 402 may be determined by comparing values within an upscaled 7×7 general activation map to a threshold value. In FIG. 4B, the general activation map may be interpolated and a different bounding box 402′ may be established based on the interpolated data.

The techniques described herein provide approximate object detection to be performed using a CNN that is designed and trained for image classification. In this sense, object detection can be achieved “for free” (i.e., with minimal resources) making it well suited for mobile apps that may be resource constrained.

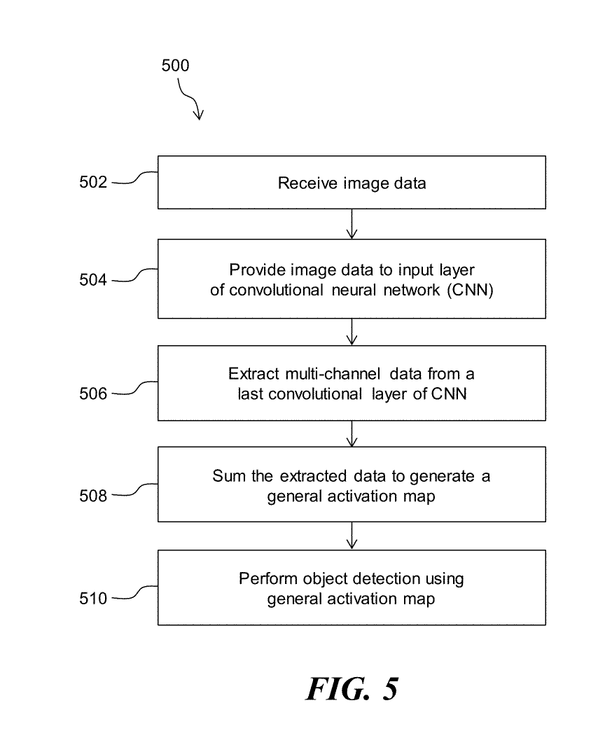

FIG. 5 is a flow diagram showing processing that may occur within the system of FIG. 1, according to some embodiments of the present disclosure. At block 502, image data may be received. In some embodiments, the image data may be converted from a specific image format (e.g., JPEG, PNG, or GIF) to a normalized (e.g., matrix-based) data representation.

At block 504, the image data may be provided to an input layer of a convolutional neural network (CNN). The CNN may include the input layer, a plurality of convolutional layers, a fully connected layer, and an output layer, where a first convolutional layer is coupled to the input layer and a last convolutional layer is coupled to the fully connected layer.

At block 506, multi-channel data may be extracted from the last convolutional layer. At block 508, the extracted multi-channel data may be summed over all channels to generate a 2-dimensional general activation map.

At block 510, the general activation map may be used to perform object detection within the image. In some embodiments, each value within the general activation map is compared to a predetermined threshold value. A bounding box may be established around the values that are above the threshold value. The bounding box may approximate the location of an object within the image. In some embodiments, the general activation map may be interpolated to determine a more accurate bounding box. In some embodiments, the general activation map and/or the bounding box may be upscaled based on the dimensions of the image.

FIG. 6 shows a user device, according to an embodiment of the present disclosure. The illustrative user device 600 may include a memory interface 602, one or more data processors, image processors, central processing units 604, and/or secure processing units 605, and a peripherals interface 606. The memory interface 602, the one or more processors 604 and/or secure processors 605, and/or the peripherals interface 606 may be separate components or may be integrated in one or more integrated circuits. The various components in the user device 600 may be coupled by one or more communication buses or signal lines.

Sensors, devices, and subsystems may be coupled to the peripherals interface 606 to facilitate multiple functionalities. For example, a motion sensor 610, a light sensor 612, and a proximity sensor 614 may be coupled to the peripherals interface 606 to facilitate orientation, lighting, and proximity functions. Other sensors 616 may also be connected to the peripherals interface 606, such as a global navigation satellite system (GNSS) (e.g., GPS receiver), a temperature sensor, a biometric sensor, magnetometer, or other sensing device, to facilitate related functionalities.

A camera subsystem 620 and an optical sensor 622, e.g., a charged coupled device (CCD) or a complementary metal-oxide semiconductor (CMOS) optical sensor, may be utilized to facilitate camera functions, such as recording photographs and video clips. The camera subsystem 620 and the optical sensor 622 may be used to collect images of a user to be used during authentication of a user, e.g., by performing facial recognition analysis.

Communication functions may be facilitated through one or more wired and/or wireless communication subsystems 624, which can include radio frequency receivers and transmitters and/or optical (e.g., infrared) receivers and transmitters. For example, the Bluetooth (e.g., Bluetooth low energy (BTLE)) and/or WiFi communications described herein may be handled by wireless communication subsystems 624. The specific design and implementation of the communication subsystems 624 may depend on the communication network(s) over which the user device 600 is intended to operate. For example, the user device 600 may include communication subsystems 624 designed to operate over a GSM network, a GPRS network, an EDGE network, a WiFi or WiMax network, and a BluetoothTM network. For example, the wireless communication subsystems 624 may include hosting protocols such that the device 6 can be configured as a base station for other wireless devices and/or to provide a WiFi service.

An audio subsystem 626 may be coupled to a speaker 628 and a microphone 630 to facilitate voice-enabled functions, such as speaker recognition, voice replication, digital recording, and telephony functions. The audio subsystem 626 may be configured to facilitate processing voice commands, voice printing, and voice authentication, for example.

The I/O subsystem 640 may include a touch-surface controller 642 and/or other input controller(s) 644. The touch-surface controller 642 may be coupled to a touch surface 646. The touch surface 646 and touch-surface controller 642 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 646.

The other input controller(s) 644 may be coupled to other input/control devices 648, such as one or more buttons, rocker switches, thumb-wheel, infrared port, USB port, and/or a pointer device such as a stylus. The one or more buttons (not shown) may include an up/down button for volume control of the speaker 628 and/or the microphone 630.

In some implementations, a pressing of the button for a first duration may disengage a lock of the touch surface 646; and a pressing of the button for a second duration that is longer than the first duration may turn power to the user device 600 on or off. Pressing the button for a third duration may activate a voice control, or voice command, module that enables the user to speak commands into the microphone 630 to cause the device to execute the spoken command. The user may customize a functionality of one or more of the buttons. The touch surface 646 can, for example, also be used to implement virtual or soft buttons and/or a keyboard.

In some implementations, the user device 600 may present recorded audio and/or video files, such as MP3, AAC, and MPEG files. In some implementations, the user device 600 may include the functionality of an MP3 player, such as an iPodTM. The user device 600 may, therefore, include a 36-pin connector and/or 8-pin connector that is compatible with the iPod. Other input/output and control devices may also be used.

The memory interface 602 may be coupled to memory 650. The memory 650 may include high-speed random access memory and/or non-volatile memory, such as one or more magnetic disk storage devices, one or more optical storage devices, and/or flash memory (e.g., NAND, NOR). The memory 650 may store an operating system 652, such as Darwin, RTXC, LINUX, UNIX, OS X, WINDOWS, or an embedded operating system such as VxWorks.

The operating system 652 may include instructions for handling basic system services and for performing hardware dependent tasks. In some implementations, the operating system 652 may be a kernel (e.g., UNIX kernel). In some implementations, the operating system 652 may include instructions for performing voice authentication.

The memory 650 may also store communication instructions 654 to facilitate communicating with one or more additional devices, one or more computers and/or one or more servers. The memory 650 may include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GNSS/Navigation instructions 668 to facilitate GNSS and navigation-related processes and instructions; and/or camera instructions 670 to facilitate camera-related processes and functions.

The memory 650 may store instructions and data 672 for an augmented reality (AR) app, such as discussed above in conjunction with FIG. 1. For example, the memory 650 may store instructions corresponding to one or more of the modules 102, 104, 108, 110 shown in FIG. 1, along with the data for one or more machine learning models 106 and/or data for images 112 being processed thereby.

Each of the above identified instructions and applications may correspond to a set of instructions for performing one or more functions described herein. These instructions need not be implemented as separate software programs, procedures, or modules. The memory 650 may include additional instructions or fewer instructions. Furthermore, various functions of the user device may be implemented in hardware and/or in software, including in one or more signal processing and/or application specific integrated circuits.

In some embodiments, processor 604 may perform processing including executing instructions stored in memory 650, and secure processor 605 may perform some processing in a secure environment that may be inaccessible to other components of user device 600. For example, secure processor 605 may include cryptographic algorithms on board, hardware encryption, and physical tamper proofing. Secure processor 605 may be manufactured in secure facilities. Secure processor 605 may encrypt data/challenges from external devices. Secure processor 605 may encrypt entire data packages that may be sent from user device 600 to the network. Secure processor 605 may separate a valid user/external device from a spoofed one, since a hacked or spoofed device may not have the private keys necessary to encrypt/decrypt, hash, or digitally sign data, as described herein.

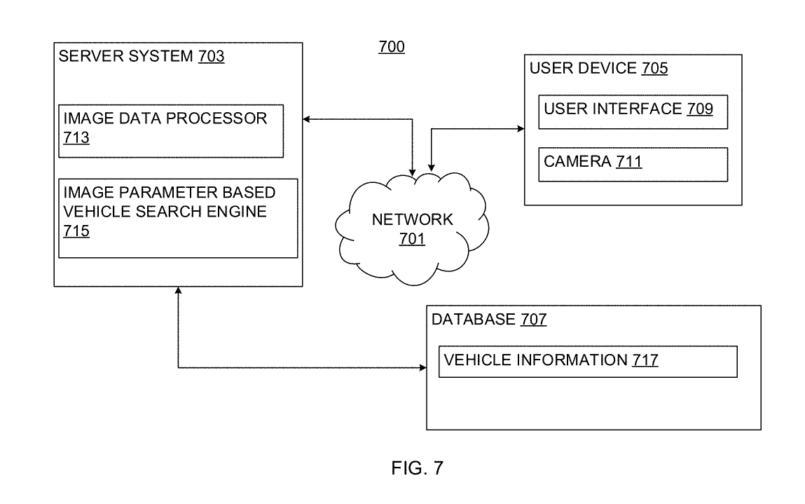

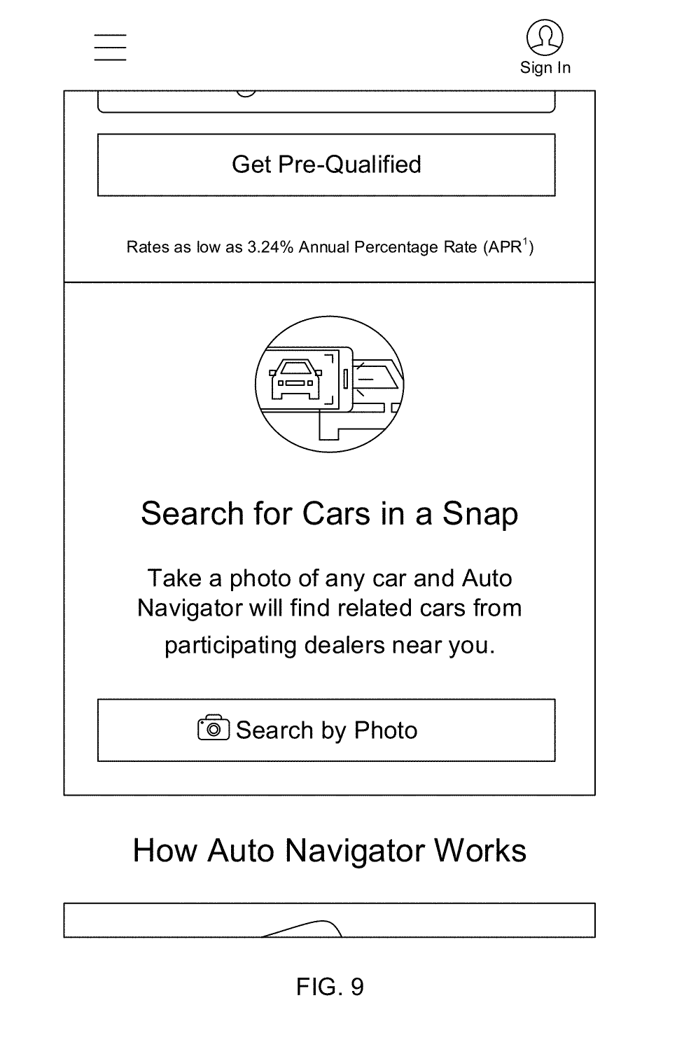

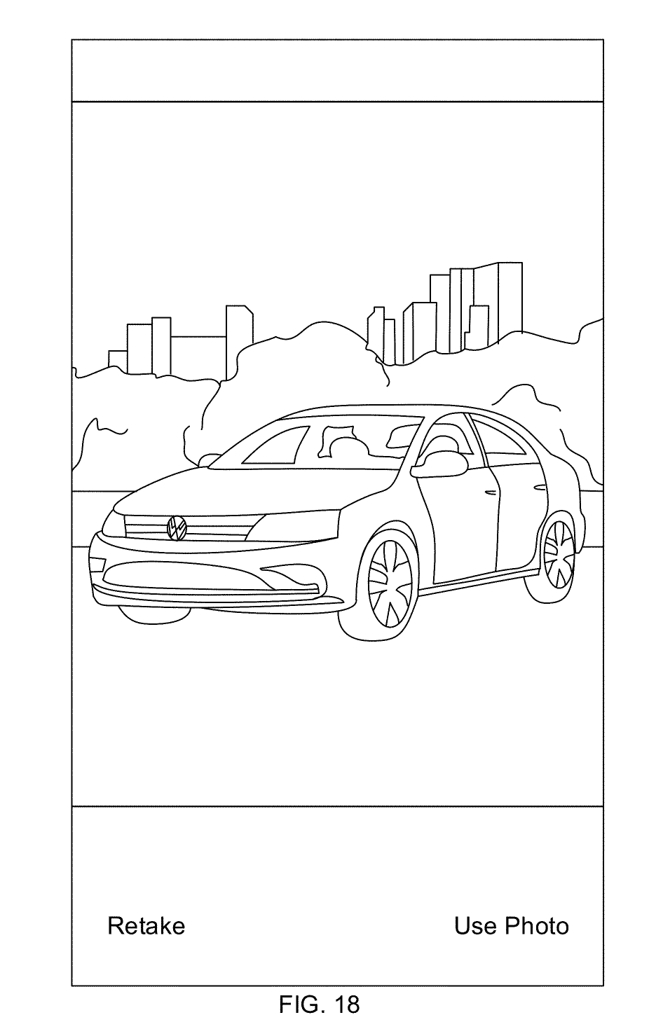

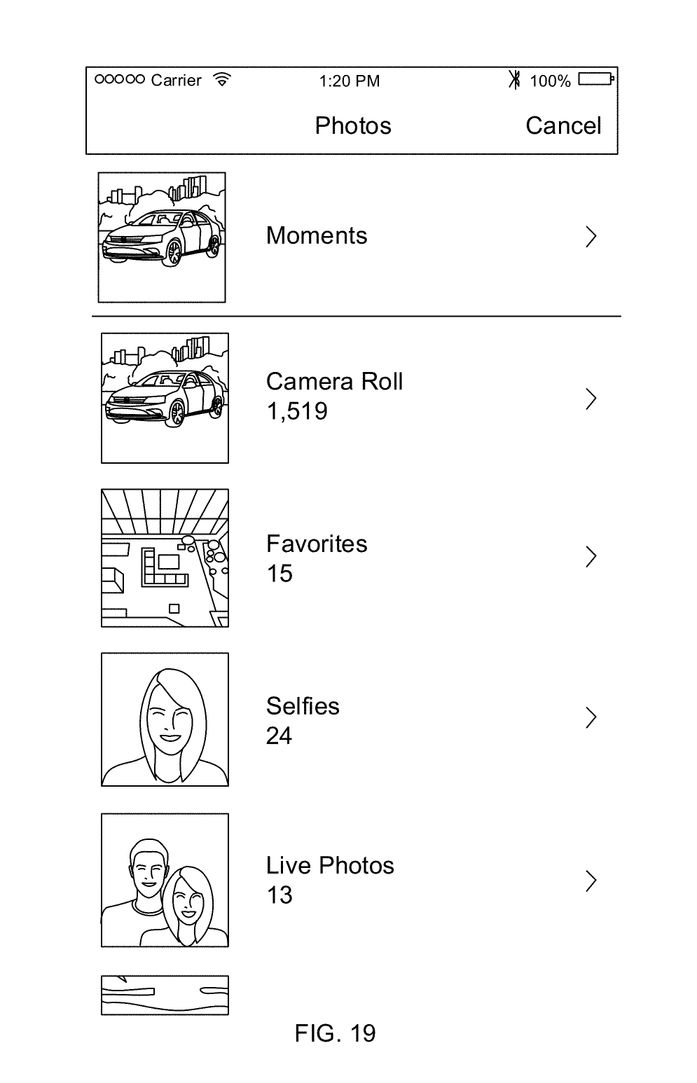

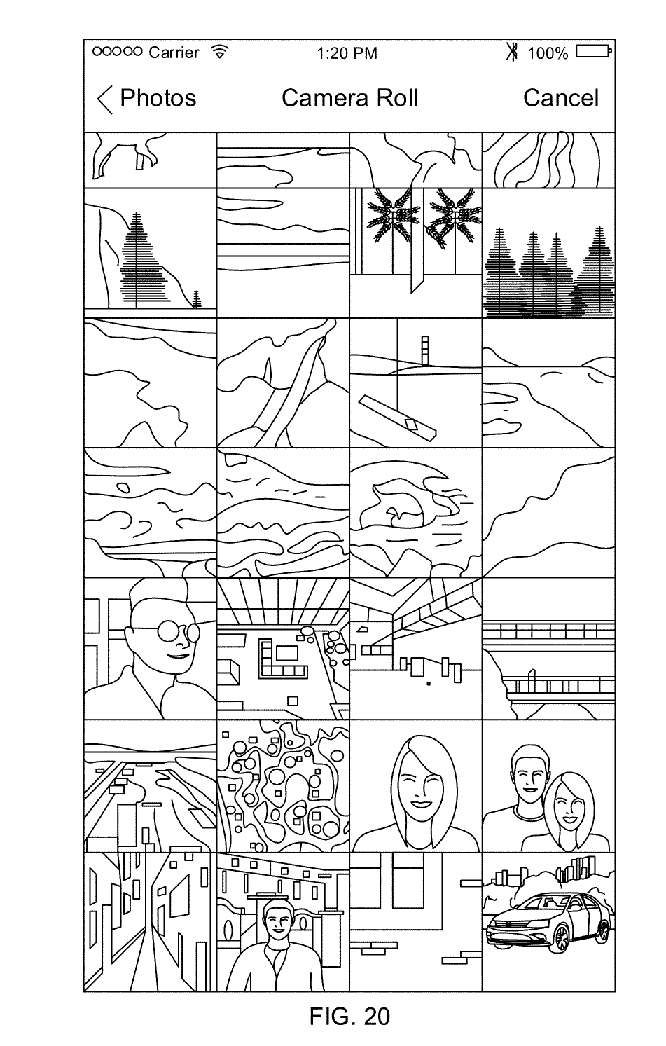

Embodiments of the present disclosure are directed toward a search engine that is capable of identifying vehicles based on a photograph or image. As described below with reference to FIGS. 9-23, embodiments of the present disclosure describe user interfaces generated by the photograph driven vehicle identification system 700 of FIG. 7. For example, the generated user interfaces may include websites and/or mobile applications configured to used car sales, new car sales, car financing, rental services, parking services and the like. In some embodiments, the system 100 for object detection and image classification of FIG. 1 may also generate the user interfaces for identifying vehicles based on a photograph or image. In some embodiments, as described below with reference to FIGS. 17-20, a web and/or mobile based vehicle search solution may be driven by a photograph of a vehicle identified by the photograph driven vehicle identification system 700 of FIG. 7. In some embodiments, the object detection techniques described above in conjunction with FIGS. 3A, 3B, 4A, and 4B may also provide the web and/or mobile vehicle search solution. The web and/or mobile based search solution may provide a detailed list of vehicles located within a vicinity of a searcher (or entered location) that are available for sale. The web and/or mobile based search solution may include information regarding pricing, vehicle specifications, photos, reviews (for the vehicle and/or dealer), dealer contact information, distance away from the searcher (or entered location), and the like.

In some embodiments, a user may take an image of one or more vehicles using a user device, and upload the image through a user interface of a server system. The server system may use one or more machine learning modules to identify the number of vehicles in the received image and generate a separate image for each of the vehicles (i.e., extracted vehicle image). The server system may then apply a machine learning module to the extracted vehicle image to identify the vehicle in the extracted vehicle image. This may generate identified vehicle information (e.g., make, model, trim, and year). The server system may then determine detailed vehicle information for each of the identified vehicles. The server system may generate an augmented image for each of the vehicles in the user provided image that includes the extracted vehicle image and identified vehicle information and/or detailed vehicle information. The augmented image(s) may be provided to the user via the user interface for the user device.

### Single Shot Detector (SSD) Inception

The Single Shot Detector (SSD) Inception as used herein is a method for detecting objects in images using a single deep neural network. The SSD inception discretizes output space of bounding boxes into a set of default boxes over different aspect ratios and scales per feature map location. At prediction time, the single deep neural network generates scores for the presence of each object category in each default box and produces adjustments to the box to better match the object shape. Additionally, the single deep neural network combines predictions from multiple feature maps with different resolutions to naturally handle objects of various sizes. The SSD Inception model is simple relative to methods that require object proposals because it completely eliminates proposal generation and subsequent pixel or feature resampling stage and encapsulates all computation in a single network. This makes SSD easy to train and straightforward to integrate into systems that require a detection component. Experimental results on the PASCAL VOC, MS COCO, and ILSVRC datasets confirm that SSD has comparable accuracy to methods that utilize an additional object proposal step and is much faster, while providing a unified framework for both training and inference. Compared to other single stage methods, SSD has much better accuracy, even with a smaller input image size. For 300×300 input, SSD achieves 72.1% mAP on VOC2007 test at 58 FPS on a Nvidia Titan X and for 500×500 input, SSD achieves 75.1% mAP, outperforming a comparable state of the art Faster R-CNN model.

FIG. 7 illustrates a system 700 for a photograph driven vehicle identification system, according to an aspect of the present disclosure. The illustrated system 700 may include a server system 703 communicatively coupled to a user device 705 by way of a network 701. The server system 703 may also be coupled to a database 707.

The server system 703 may include an image data processor 713 configured to receive and process images received from the user device 705. The server system 703 may also include an image parameter based vehicle search engine 715 that may query a database 707 to retrieve vehicle information 717 for vehicles identified as matching parameters determined by the image data processor 713.

The user device 705 may include a camera 711 capable of obtaining an image of a car. The user device 705 may also include a user interface 709 such as a website, mobile application, or the like. The mobile device 705 may communicate over the network 703 using programs or applications. In one example embodiment, methods of the present disclosure may be carried out by an application running on one or more mobile devices and/or a web browser running on a stationary computing device. In some embodiments the user interface 709 may include a graphical user interface. In some embodiments, the user may have to provide login credentials to access the user interface 709. The database 707 may include one or more data tables, data storage structures and the like.

The network 701 may include, or operate in conjunction with, an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks.

Although one computing device (i.e., server system 703, and user device 705) may be shown and/or described, multiple computing devices may be used. Conversely, where multiple computing devices are shown and/or described, a single computing device may be used.

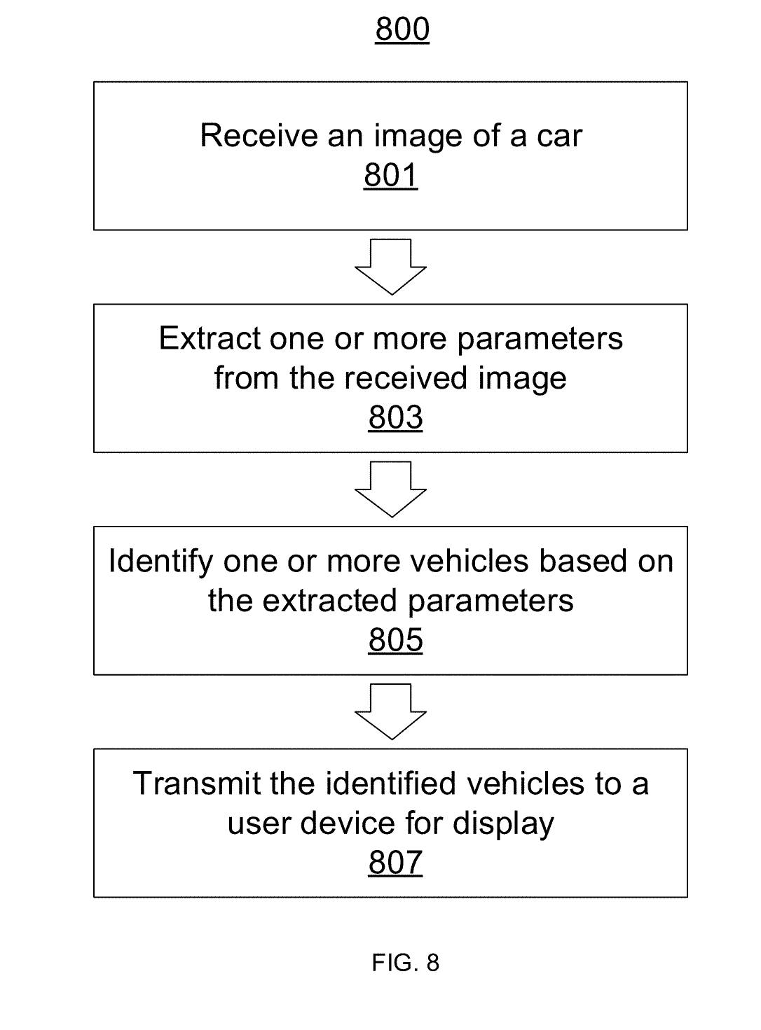

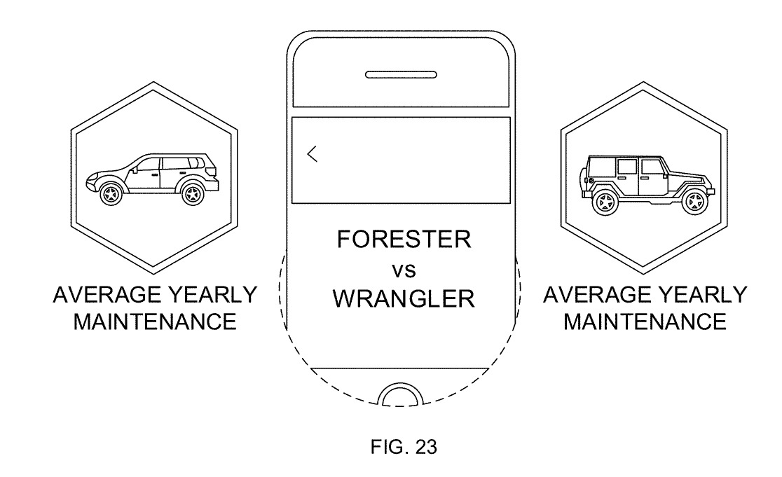

FIG. 8 illustrates a method 800 for a photograph driven vehicle identification system, according to an aspect of the present disclosure. In a first step 801, a server system, such as the server system 703 of FIG. 7 may receive an image of a car. In a second step 803, an image data processor such as the image data processor 713 of FIG. 7, may extract one or more parameters from the received image. In a third step 805, an image parameter based vehicle search engine such as image parameter based vehicle search engine 715 of FIG. 7 may identify one or more vehicles based on the extracted parameters. In some embodiments, step 805 may include matching one or more of the extracted parameters with parameters of vehicles stored in the vehicle information 717 component of the database 707. In a fourth step 807, the server system may transmit the identified vehicle(s) to a user device such as user device 705. The user device 705 can include a camera that can obtain one or more images. The user device 705 can provide a display including one or more images of a vehicle and information associated with the vehicle through a user interface of the user device 705. In some configurations, the display can include a first portion provided at a first location of the user interface, and a second portion provided at a second location different from the first location. As described below with reference to FIG. 23, the user device 705 can provide each of the first portion (e.g. an augmented image of a first car) and the second portion (e.g. an augmented image of a second car) at a single instance (i.e. at the same time). Note that the user device 705 presents an improved user interface with a display including augmented images of identified vehicles at the single instance. The improved user interface allows a user of the user device 705 to make a visual comparison of information associated with identified vehicles, and the user can make a decision to perform a financial transaction (e.g. buying, selling, leasing, etc.) based on the visual comparison.

In some embodiments, at step 801, the server system may receive an image from a user via the user device 705 that may include multiple vehicles within the same image. In such an embodiment, the image data processor of step 803 may use a library and or object detection application interface (e.g., TensorFlow®) and a machine learning model (e.g., Single Shot Detector) to identify parameters such as the number of vehicles present in the uploaded picture, the coordinates for each identified vehicle in the image, the dimensions for each identified vehicle in the image, and the like. The image data processor may also crop or resize the obtained image to create separate images for each identified vehicle within the image. The image parameter based vehicle search engine 715 at step 805 may use the identified parameters (e.g., dimensions), a library or object detection application interface (e.g., TensorFlow®) and a machine learning model, to predict the make, model, trim and/or year of a vehicle that matches the identified parameters. The identified vehicle's image, make, model, trim and/or year information may be displayed to the user at step 807. In some embodiments the processes described above may utilize one or more Representational State Transfer (REST) application programming interfaces.

In some embodiments, a user may provide the server system with an image having a plurality of vehicles. In some embodiments, the image may be a photograph taken by the user using a mobile device, cell phone, tablet camera, or the like. In some embodiments, the image may be a stock photograph, an image obtained from the internet, an image from a movie, television show, or the like. The user provided image may be received at the server system. The server system may then apply one or more machine learning algorithms to the image to remove non-vehicle objects from the image. For example, in some embodiments, a Single Shot Detector Inception machine learning algorithm may be used to remove non-vehicle objects from the image. Non-vehicle objects may include, but are not limited to, people, cats, dogs, pets, trees, buildings, signs, and the like.

The one or more machine learning algorithms and related libraries (e.g., Single Shot Detector Inception) may also identify the number of vehicles in the image along with the location of the vehicles within the image. In one embodiment, the machine learning algorithm may be used to generate two coordinates that define two diagonal points of a rectangle that surrounds a vehicle in the image. In some embodiments, one or more coordinates may be provided corresponding to any suitable shape. In some embodiments, the generated coordinates may be represented in a float coordinate system. In some embodiments, the generated coordinates represented in a float coordinate system may be converted to coordinates in a pixel coordinate system corresponding to the user provided image.

In some embodiments, the converted pixel coordinates may be used to extract one or more vehicle images from the user provided image. In some embodiments, the extracted vehicle images may be stored in a database to provide a training data set for machine learning algorithms. In such an embodiment, the extracted vehicle images may be anonymized before storage in the database. In some embodiments, the extracted vehicle images may be stored without anonymization. In some embodiments, vehicle data corresponding to the extracted vehicle images may be stored alongside the extracted vehicle images. Vehicle data may be retrieved using the processes described below.

In some embodiments, each of the extracted vehicle images may be provided to a machine learning algorithm that is configured to identify the vehicle in the extracted vehicle image. For example, the machine learning algorithm may include a TensorFlow® model. The machine learning algorithm may be trained on images and may be configured to generate identified vehicle information including a vehicle's make, model, year, and/or trim when provided with an extracted vehicle image that shows vehicle shape (e.g. headlights, windshield shape, body style, bumper, etc.).

In some embodiments, the identified vehicle information (i.e., make, model, year and/or trim) may be transmitted to another component of the server system that is configured to retrieve detailed vehicle information. The detailed vehicle information may include mileage, pricing, vehicle stock, location of the car dealer, color, customer ratings (of the car and/or dealer), body style, and the like for each of the identified vehicles.

In some embodiments, the identified vehicle information and/or detailed vehicle information may be overlaid upon the corresponding extracted vehicle image to form an augmented image. In some embodiments, the augmented image may be saved on a user's computer device and/or a database communicatively coupled to the server system. In some embodiments the augmented image may be saved in a user profile of a mobile application or website. In some embodiments the augmented image may be generated in real time. For example, the augmented image may be generated with updated detailed vehicle information for a stored extracted vehicle image.

In some embodiments, augmented images for each of the extracted vehicles may be displayed to a user using a user interface. Augmented images may be displayed concurrently, or in series. For example, a user may flip, or scroll thru a collection of augmented images. In some embodiments the augmented images may be provided to the user as an image gallery. In this manner, the described system is able to provide a user with a detailed comparison of the vehicles the user photographed. The described system may be compatible with a website, a mobile application and the like.

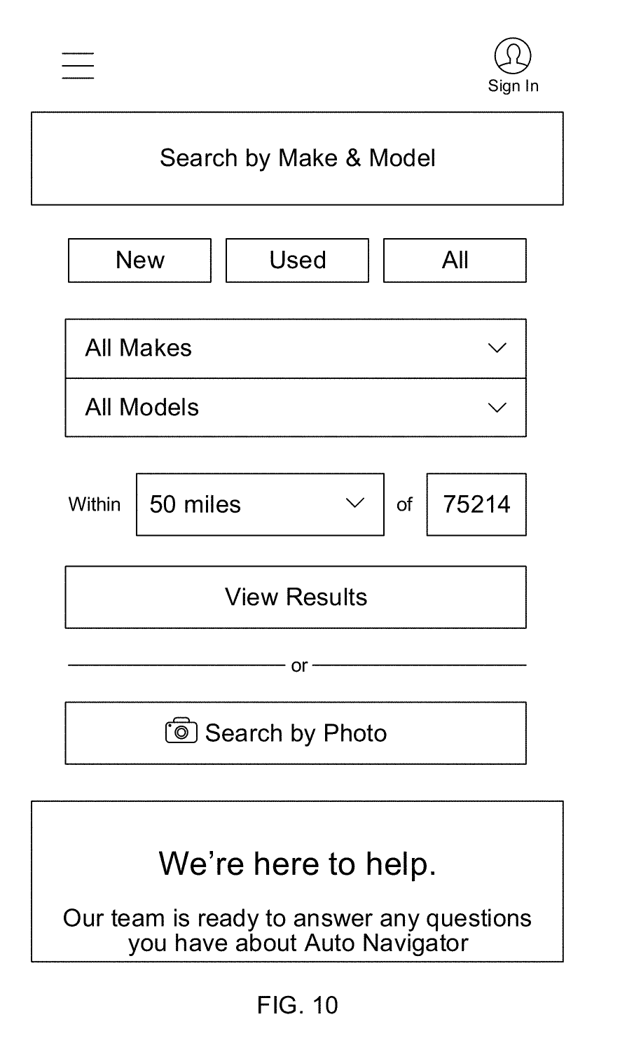

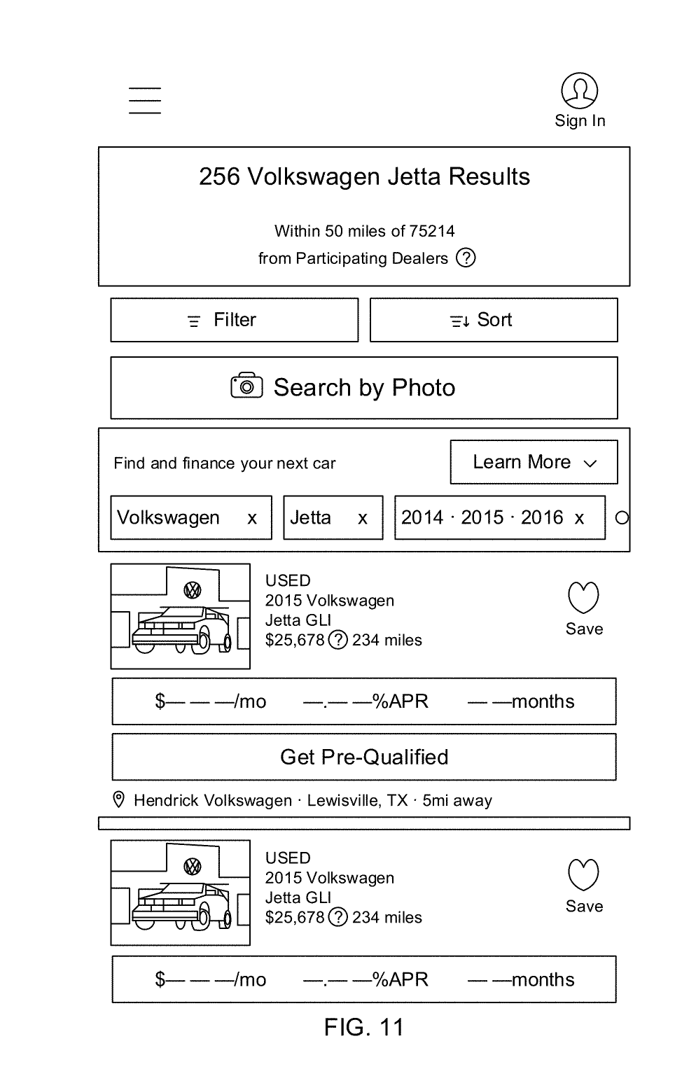

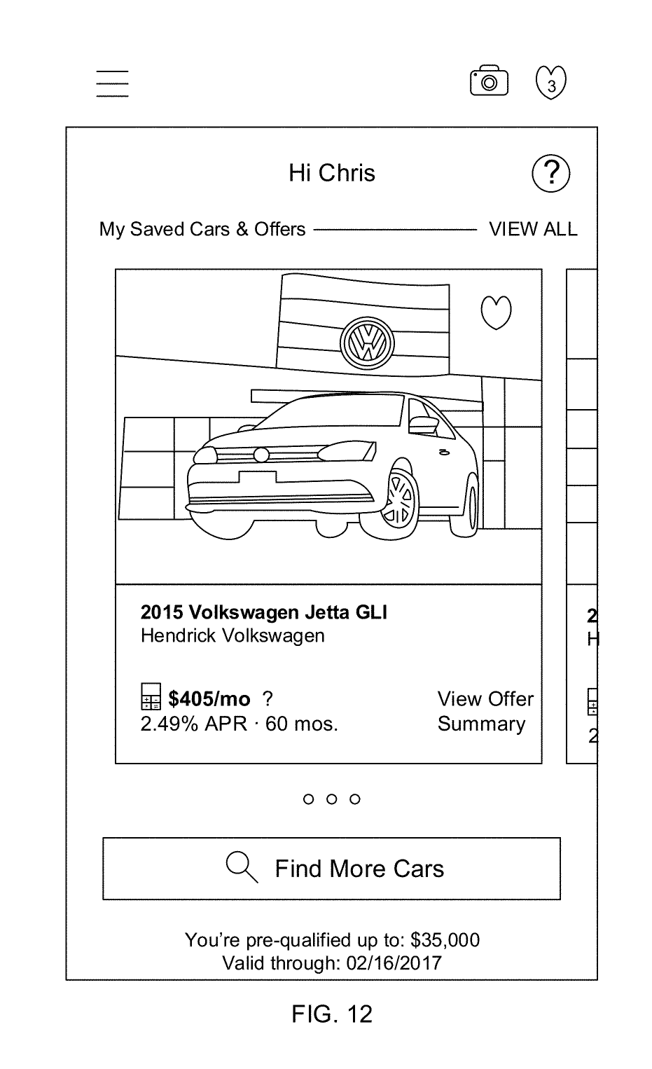

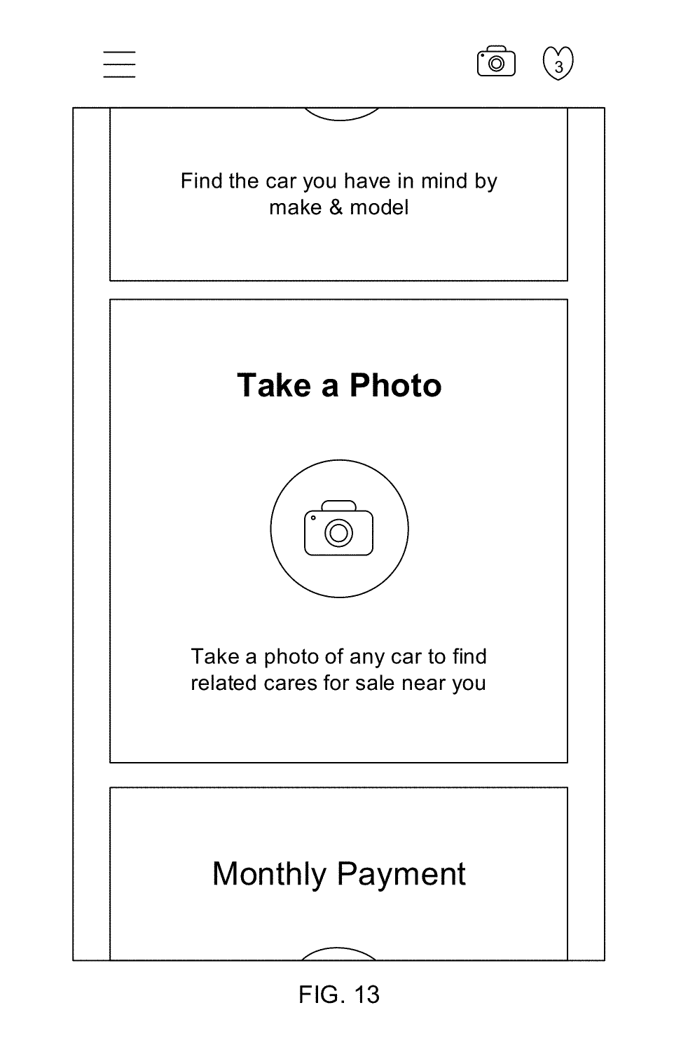

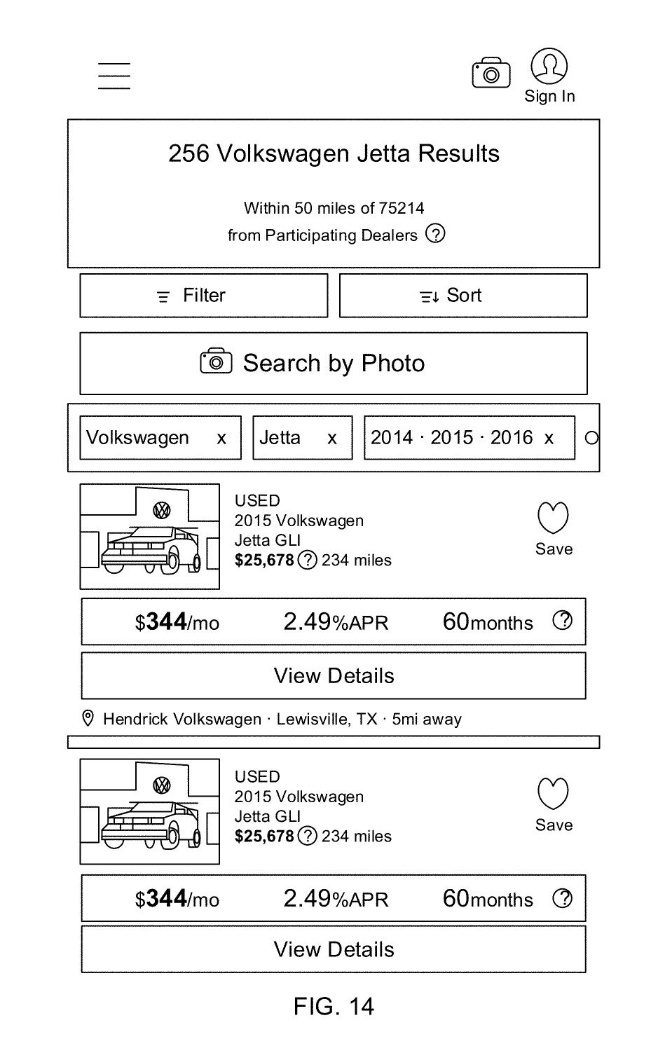

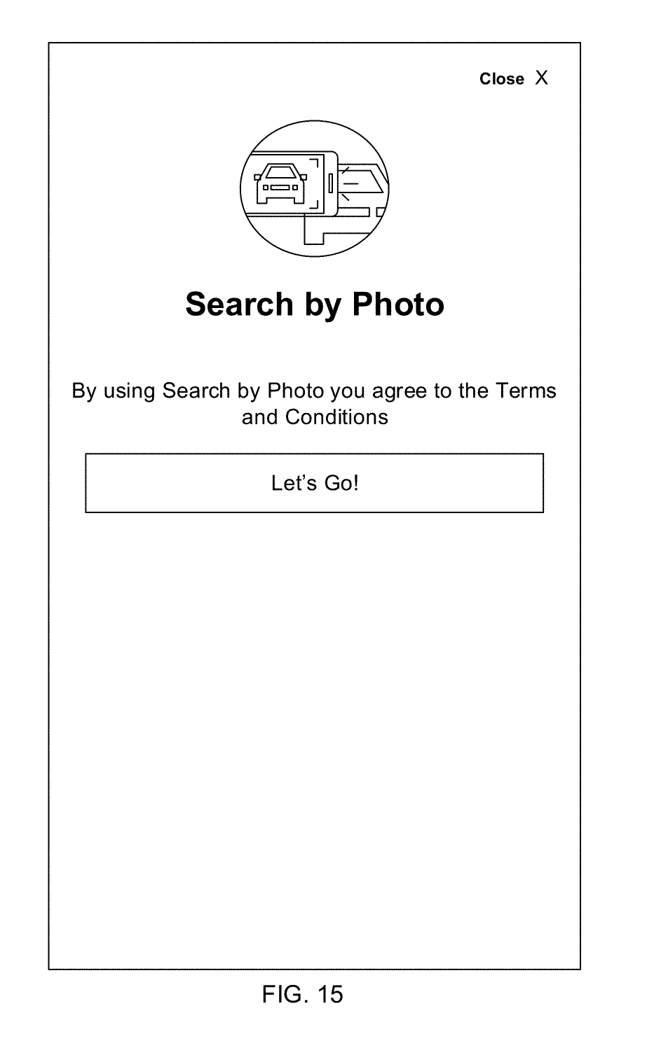

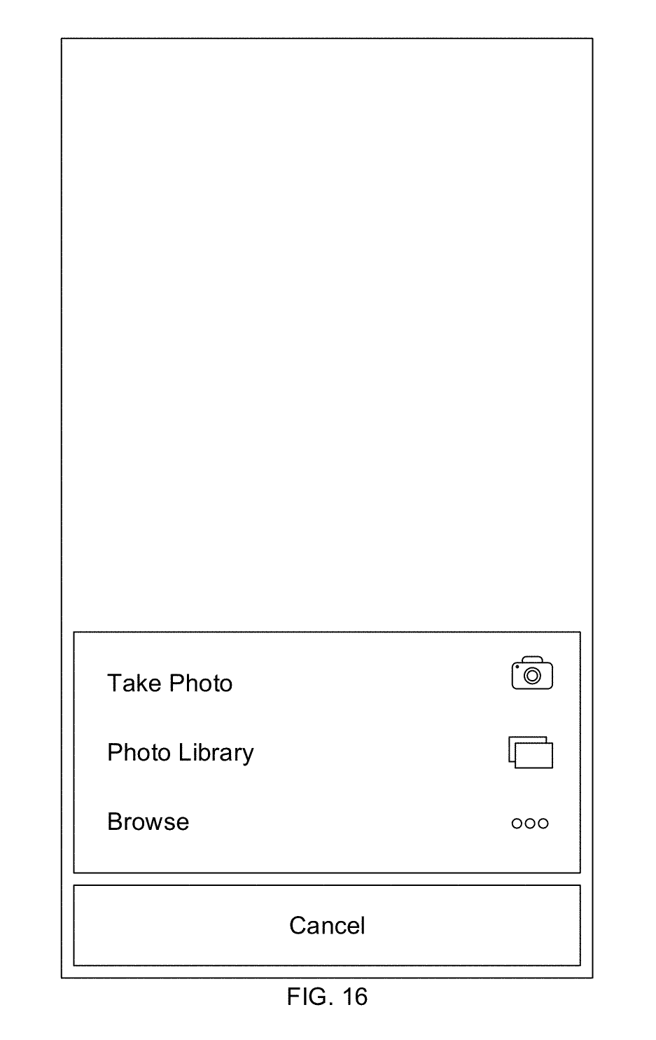

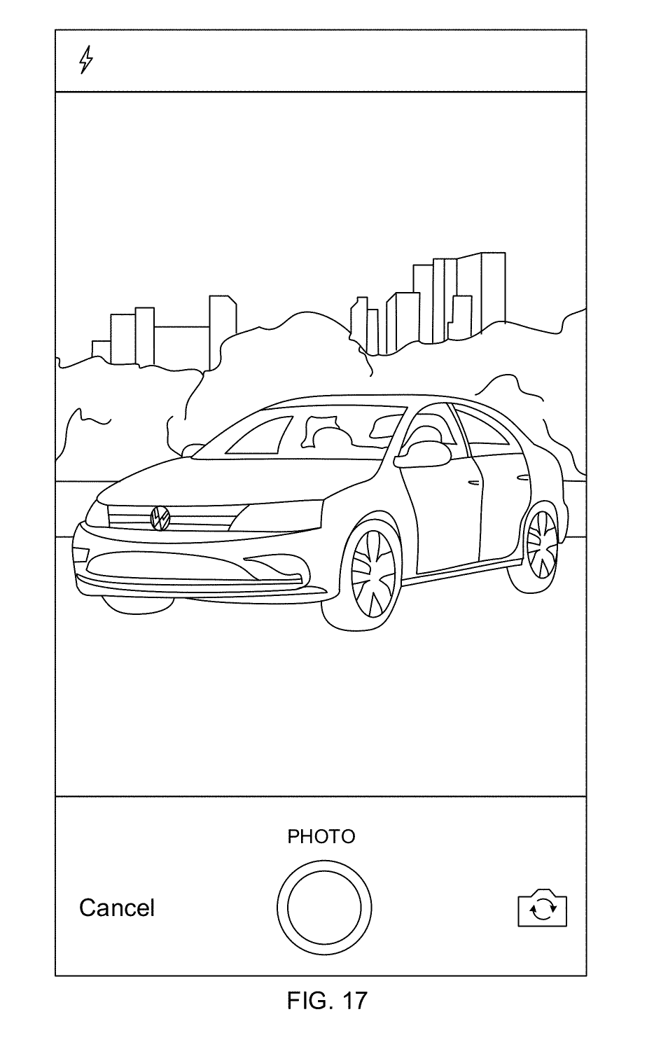

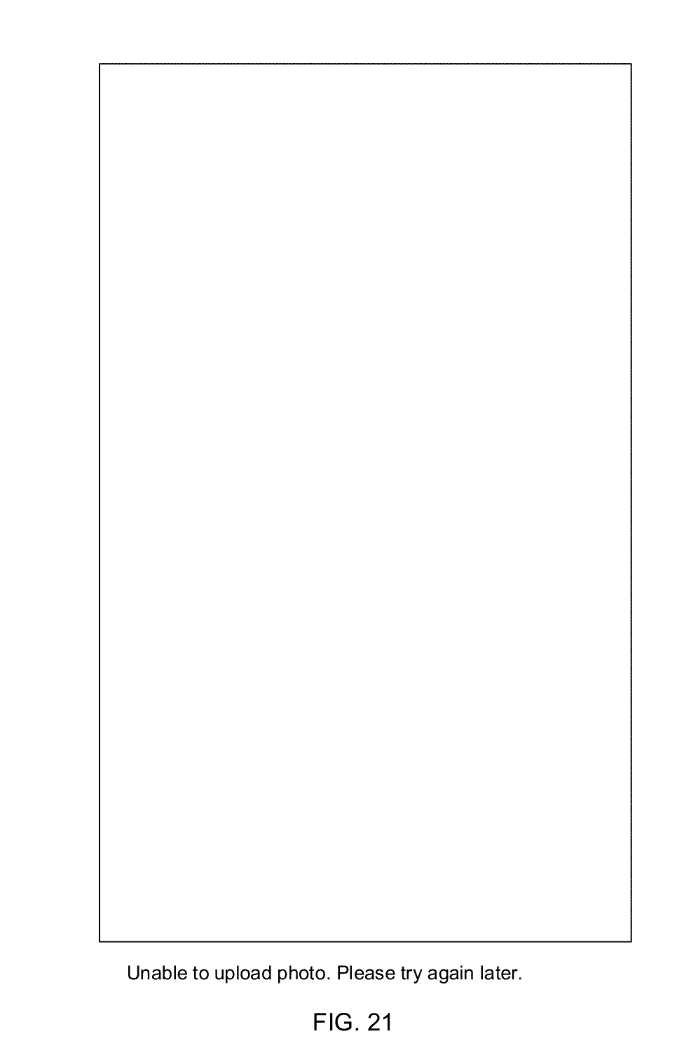

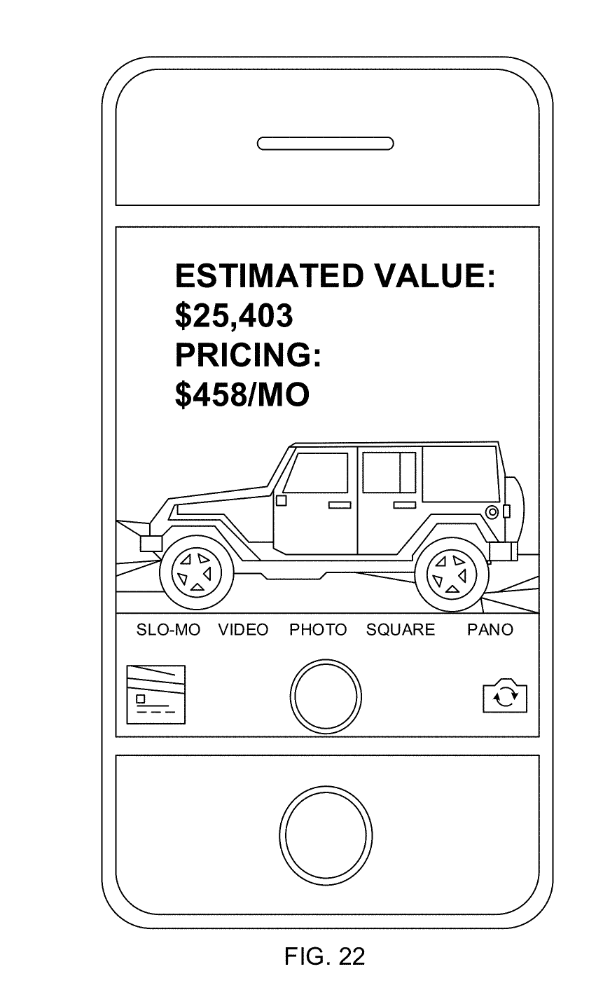

FIGS. 9-23 illustrate user interfaces for a photograph driven vehicle identification system, according to an aspect of the present disclosure. In some embodiments, the user interface is a webpage associated with the photograph driven vehicle identification system 700, as described above with reference to FIG. 7. For example, FIG. 9 illustrates a landing page, where a user may elect to search for cars related to the searched car that are located at nearby car dealers using an image. FIG. 10 illustrates a search page, where a user may elect to search for cars by entering a make and/or model or by an image. FIG. 11 illustrates the results that may be displayed to a user based on the search for cars by photograph and/or make and model. FIG. 12 illustrates that a user may view previously viewed and/or saved cars. FIG. 13 illustrates that a user may take a photograph of a car to find related cars that are on sale near the user. FIG. 14 illustrates the results that may be displayed to a user based on the search for cars by photograph and/or make and model. FIG. 15 illustrates that the web or mobile application may accept terms and conditions prior to using the application. In some embodiments, the web or mobile application may request that the user not use the photograph search to photograph another person's car, while driving, and the like. Instead, the web or mobile application may encourage a user to take photographs of cars from dealership locations during the dealership's business hours. FIG. 16 illustrates that the user interface may integrate with a camera on the user device in order to allow the user to take a photograph or upload a stored photograph or image to the interface for transmittal to the server. FIGS. 17-20 illustrate an image that may be used for a search and that the user interface may integrate with a camera on the user device. FIG. 21 illustrates a display on a user interface when a user takes an image of a vehicle. FIG. 22 illustrates a display on a user interface that shows the user provided image overlaid with identified vehicle information and/or detailed vehicle information. In some embodiments, this may be referred to as an augmented image. As shown, the augmented image may be stored on the user device. As discussed above, the augmented image may be stored in a user profile. Alternatively, the augmented image may be regenerated with up-to-date identified vehicle information. FIG. 23 illustrates a display on a user interface, that shows that the described embodiments may be used to provide a user of a comparison between vehicles. The display shown in FIG. 23 includes a first portion (i.e. augmented image of a car on the left) provided at a first location of the user interface, and a second portion (i.e. augmented image of a car on the right) provided at a second location. The user interface provides each of the two augmented images at the same time. Note that the improved user interface in the display shown in FIG. 23 includes augmented images of identified vehicles (i.e. an augmented image of a Forester car and an augmented image of a Wrangler image) displayed at the same time. The improved user interface allows a user of the user device 705 to make a visual comparison of information (e.g. average yearly maintenance costs) associated with identified vehicles, and the user can make a decision to perform a financial transaction (e.g. buying, selling, leasing, etc.) based on the visual comparison.

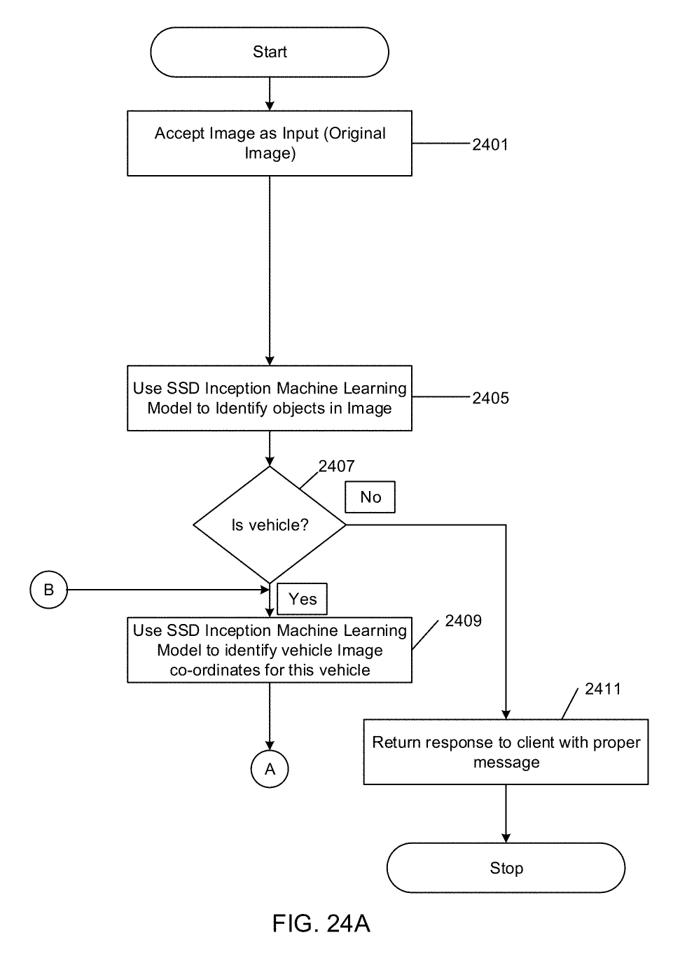

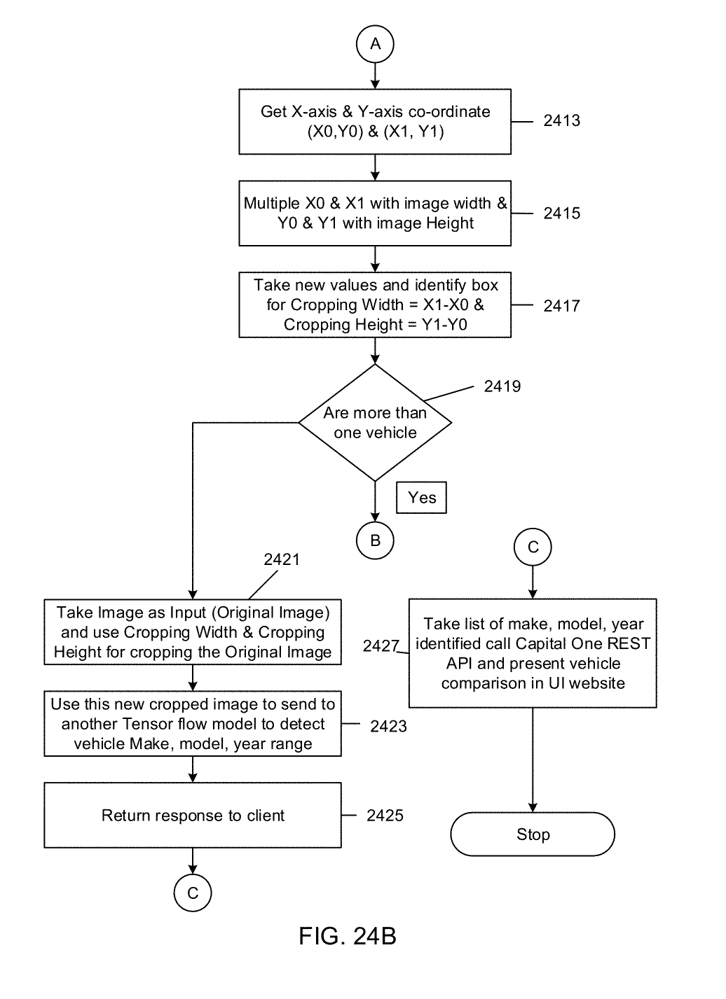

FIGS. 24A and 24B illustrate an example process for vehicle identification and comparison according to an aspect of the present disclosure. The illustrated processes may be implemented by a server system such as server system 703 of FIG. 7. The server system may start at element A of FIG. 24A, where it accepts an original image as an input 2401. In the illustrated example, a Single Shot Detector (SSD) Inception Machine Learning Model may be used to identify objects in the image 2405. The SSD Inception Machine Learning Model may determine if identified objects are vehicles or not vehicles 2407. In the event that the identified object is not a vehicle, a response may be returned to a client (i.e., user) 2411. In the event that the identified object is a vehicle, the SSD Inception Machine Learning Model may be used to identify the vehicle image coordinates for this vehicle 2409.

The example process may continue as illustrated in FIG. 24B. After the SSD Inception Machine Learning model is used to identify the vehicle image coordinates for this vehicle, the x-axis (i.e., x0, x1) and y-axis (i.e., y0, y1) coordinates may be obtained 2413. Then, the obtained x-axis and y-axis coordinates may be scaled with the image width and the image height, respectively 2415. The scaled values may be used to identify a box that surrounds the vehicles 2417. The box may define a cropping width and a cropping height. If there is more than one vehicle 2419 the described process may continue for the number of vehicles present in the original image (as shown in element B in FIGS. 24A and 24B).

The cropping width and cropping height may be applied to the original image to generate a cropped image 2421. The cropped image may then be sent to a Tensor Flow model to detect the make, model, and/or year range for the vehicle 2423. The detected make, model, and/or year range may be provided to a separate process 1925 (as shown in element C in FIG. 24B). In an example process at element C of FIG. 24B, a list of vehicle makes, model, and/or year ranges may be presented to a user device using a REST API 2427.

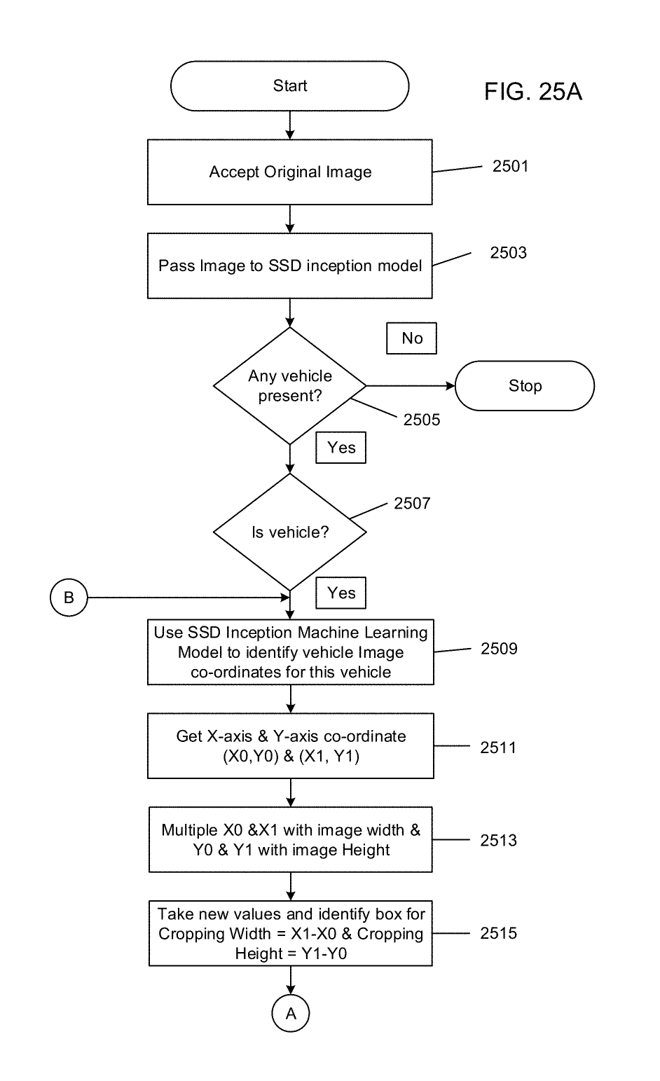

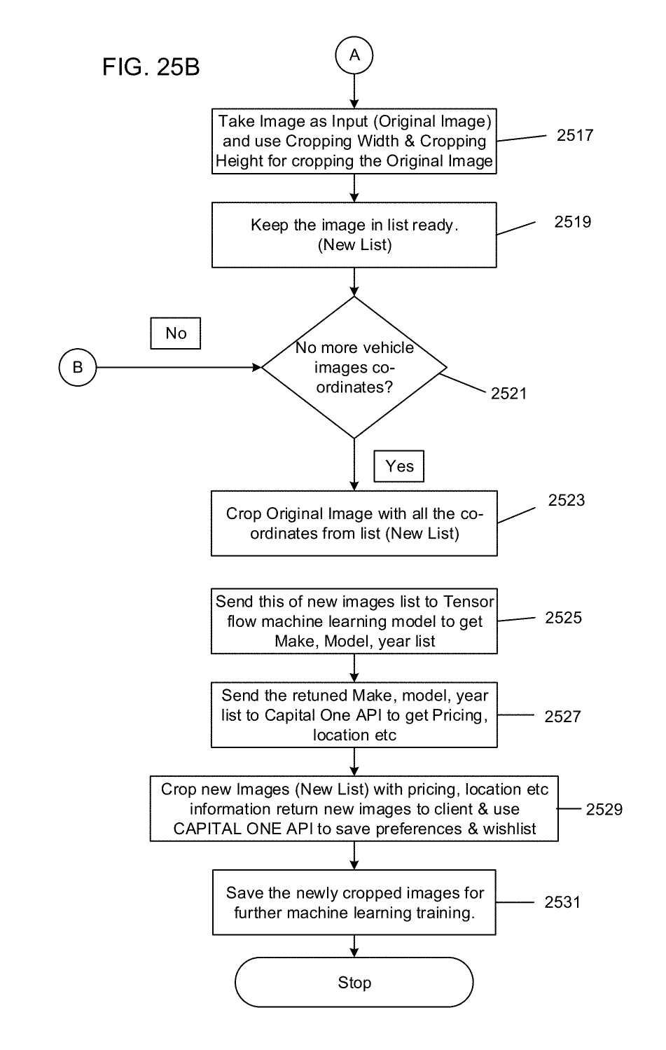

FIGS. 25A and 25B illustrate an example process for vehicle pricing by photo and an example process for saving vehicle pricing to a wishlist to visit later, according to an aspect of the present disclosure. The illustrated processes may be implemented by a server system such as server system 703 of FIG. 7. The server system may start by accepting an original image as an input 2501. In a second step, the server system may pass the image to an SSD inception model 2503. The SSD inception model may then determine whether any vehicle is present 2505. If no vehicle is present, the process may stop. If a vehicle is present, it may then determine whether there is more than one vehicle in the image 2507. If more than one vehicle is present, the SSD inception model may be used to identify vehicle image coordinates for all vehicles in the image 2509. The x-axis and y-axis coordinates may be determined for each image 2511. The x-axis and y-axis coordinates may be scaled by the image width and image height 2513. The new values may be used to identify a box with a given cropping width and cropping height 2515. The process illustrated in FIG. 25A may continue at element A of FIG. 25B.

The process may continue by taking the original image as input 2517. The cropped coordinates may be added to a list or used to create a new list 2519. If there are additional vehicle coordinates available 2521 the process may continue at element B of FIGS. 25A and 25B.

If there are no additional vehicle coordinates available 2521 the process may continue by applying the list of cropping coordinates to the original image to generate a list of new images 2523. The list of new images may be sent to a Tensor Flow Machine Learning model to get the make, model and year list 2525. The make, model and year list may be sent to an application interface to retrieve pricing, location and additional information 2527. The new images with the pricing, location, and additional information may be returned to client (displayed to a user) using an application interface. The user may save the new images to a preferences list and/or wishlist 2529. The process may also save the newly cropped images for further machine learning training 2531.

The steps illustrated by the processes depicted in FIGS. 24A-25B may be performed in any suitable order. In some embodiments, the steps may be combined. Some embodiments of the present disclosure may reduce the time required by a user using the website to view and/or select a car of their choosing.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

In some examples, each of the user device and the server system may be implemented by a computer system (or a combination of two or more computer systems). Computer systems may include a set of instructions for causing the machine to perform any one or more of the methodologies, processes or functions discussed herein may be executed. In some examples, the machine may be connected (e.g., networked) to other machines as described above. The machine may operate in the capacity of a server or a client machine in a client-server network environment, or as a peer machine in a peer-to-peer (or distributed) network environment. The machine may be any special-purpose machine capable of executing a set of instructions (sequential or otherwise) that specify actions to be taken by that machine for performing the functions describe herein. Further, while only a single machine is illustrated, the term “machine” shall also be taken to include any collection of machines that individually or jointly execute a set (or multiple sets) of instructions to perform any one or more of the methodologies discussed herein. A computer system may include processing components, memory, data storage components, and communication components which may communicate with each other via a data and control bus. In some embodiments a computer system may also include a display device and/or user interface.

Processing components may include, without being limited to, a microprocessor, a central processing unit, an application specific integrated circuit (ASIC), a field programmable gate array (FPGA), a digital signal processor (DSP) and/or a network processor. Processing components may be configured to execute processing logic for performing the operations described herein. In general, processing components may include any suitable special-purpose processing device specially programmed with processing logic to perform the operations described herein.

Memory may include, for example, without being limited to, at least one of a read-only memory (ROM), a random access memory (RAM), a flash memory, a dynamic RAM (DRAM) and a static RAM (SRAM), storing computer-readable instructions executable by processing components. In general, memory may include any suitable non-transitory computer readable storage medium storing computer-readable instructions executable by processing components for performing the operations described herein. In some embodiments computer systems may include two or more memory devices (e.g., dynamic memory and static memory).

Computer systems may include communication interface devices, for direct communication with other computers (including wired and/or wireless communication), and/or for communication with network 701 (see FIG. 7). In some examples, computer systems may include display devices (e.g., a liquid crystal display (LCD), a touch sensitive display, etc.). In some examples, computer systems may include user interfaces (e.g., an alphanumeric input device, a cursor control device, etc.).

In some examples, computer systems may include data storage devices storing instructions (e.g., software) for performing any one or more of the functions described herein. Data storage devices may include any suitable non-transitory computer-readable storage medium, including, without being limited to, solid-state memories, optical media and magnetic media.

In some examples, some or all of the logic for the above-described techniques may be implemented as a computer program or application or as a plug in module or sub component of another application. The described techniques may be varied and are not limited to the examples or descriptions provided. In some examples, applications may be developed for download to mobile communications and computing devices, e.g., laptops, mobile computers, tablet computers, smart phones, etc., being made available for download by the user either directly from the device or through a website.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer- readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples.

What is claimed is:

1. A system for image-based vehicle identification, the system comprising:
a database comprising a plurality of vehicle information;
an image data processor configured to apply one or more machine learning models on one or more images received by a user device, wherein the user device comprises a camera configured to obtain one or more images, wherein the user device is configured to provide a display comprising one or more images of a vehicle and information associated with the vehicle through a user interface of the user device, wherein the display comprises a first portion provided at a first location of the user interface, and a second portion provided at a second location different from the first location, each of the first portion and the second portion provided at a single instance; and
a vehicle search engine configured to identify one or more vehicles in the images received from the user device.

2. The system of claim 1, wherein each of the one or more machine learning models identify a plurality of objects in the received images, at least one of the plurality of objects is a vehicle.

3. The system of claim 1, wherein the vehicle search engine is configured to identify a plurality of vehicle image co-ordinates corresponding to the one or more vehicles in the images received from the user device using a Single Shot Detector Inception machine learning model.

4. The system of claim 1, wherein the image data processor is configured to generate a detailed vehicle information based on the vehicle information retrieved from the database for each of the identified vehicles.

5. The system of claim 4, wherein the detailed vehicle information comprises at least one of: a mileage information, a pricing information, a vehicle stock information, a location of a vehicle dealer, a color information, one or more customer rating information, and a body style information.

6. The system of claim 4, wherein the image data processor is configured to generate an augmented image for each of the identified vehicles by overlaying the detailed vehicle information upon an image of at least one of the identified vehicles.

7. The system of claim 6, wherein the user device is configured to display the augmented image for each of the identified vehicles through the user interface of the user device.

8. The system of claim 1, wherein the image data processor is configured to:
receive image data for the one or more images obtained by the camera, wherein the image data is received in a system comprising a convolutional neural network (CNN), the CNN comprising an input layer, a first convolutional layer coupled to the input layer, a last convolutional layer, a fully connected layer coupled to the last convolution layer, and an output layer;
extract multi-channel data from the output of the last convolutional layer;
sum the extracted data to generate a general activation map;
detect a location of an object within the one or more images by applying the general activation map to the received image data;
receive one or more classifications of the output layer; and
display the one or more images and a content overlay, wherein a position of the content overlay relative to the one or more images is determined using the detected object location, wherein the content overlay comprises information determined by the one or more classifications.

9. The system of claim 1, wherein the image data processor is configured to:
identify a plurality of vehicle image co-ordinates for each identified vehicle;
perform a cropping of each of the one or more received images in accordance with the identified vehicle image co-ordinates;
generate one or more cropped images from the one or more received images; and
store the generated cropped images of the identified vehicle in the database.

10. The system of claim 9, wherein the image data processor is configured to perform the cropping of each of the one or more received images based on a scaling of the identified vehicle image co-ordinates in accordance with a plurality of parameters associated with the one or more received images.

11. A method for image-based vehicle identification, the method comprising:
receiving one or more images from a user device;
extracting one or more parameters corresponding to at least one of the received images;
providing the determined one or more parameters as input to one or more machine learning models;
obtaining, as an output from the one or more machine learning models, a prediction of one or more vehicle information, each vehicle information corresponding to a vehicle in the obtained one or more images, at least one of the one or more machine learning models being a Single Shot Detector Inception machine learning model;
identifying, from the one or more predicted vehicle information obtained from the one or more machine learning models, one or more vehicles matching the vehicle in the obtained one or more images; and
presenting a display with the one or more identified vehicles to the user device.

12. The method of claim 11, further comprising, for each of the vehicles identified from the one or more predicted vehicle information:
generating a detailed vehicle information based on a vehicle information retrieved from a database.

13. The method of claim 12, wherein the detailed vehicle information comprises at least one of: a mileage information, a pricing information, a vehicle stock information, a location of a vehicle dealer, a color information, one or more customer rating information, and a body style information.

14. The method of claim 12, further comprising:
generating an augmented image for each of the identified vehicles by overlaying the detailed vehicle information upon an image of at least one of the one or more identified vehicles.

15. The method of claim 14, further comprising:
displaying the augmented image for each of the identified vehicles through an user interface of the user device.

16. The method of claim 11, further comprising:
receiving image data for the one or more images obtained by the camera, wherein the image data is received in a system comprising a convolutional neural network (CNN), the CNN comprising an input layer, a first convolutional layer coupled to the input layer, a last convolutional layer, a fully connected layer coupled to the last convolution layer, and an output layer;
extracting multi-channel data from the output of the last convolutional layer;
summing the extracted data to generate a general activation map;
detecting a location of an object within the one or more images by applying the general activation map to the received image data;
receiving one or more classifications of the output layer; and
displaying the one or more images and a content overlay, wherein a position of the content overlay relative to the one or more images is determined using the detected object location, wherein the content overlay comprises information determined by the one or more classifications.

17. The method of claim 11, further comprising:
identifying a plurality of vehicle image co-ordinates for each identified vehicle matching the vehicle in the obtained one or more images;
performing a cropping of each of the one or more received images in accordance with the identified vehicle image co-ordinates;
generating one or more cropped images from the one or more received images; and
storing the generated cropped images of the identified vehicle in a database.

18. The method of claim 17, wherein performing the cropping of each of the one or more received images is based on a scaling of the identified vehicle image co-ordinates in accordance with a plurality of parameters associated with the one or more received images.

19. The method of claim 11, wherein the Single Shot Detector Inception machine learning model is configured to identify a plurality of vehicle image co-ordinates corresponding to the one or more vehicles in the one or more images received from the user device.

20. A non-transitory computer-readable storage medium comprising instructions executable by a processor, the instructions comprising:
receiving one or more images from a user device;
extracting one or more parameters corresponding to at least one of the received images;
identifying, based on inputting the extracted one or more parameters to one or more machine learning models, one or more vehicles matching a vehicle in the images received from the user device, at least one of the one or more machine learning models being a Single Shot Detector Inception machine learning model configured to identify a plurality of vehicle image co-ordinates corresponding to the one or more vehicles in the one or more images received from the user device;
generating an augmented image for each of the identified vehicles based on overlaying a vehicle information upon an image of at least one of the one or more identified vehicles; and
transmitting the augmented image to the user device for display.
